(19) United States
(12) Patent Application Publication
(10) Pub. No.: US 2017/0053540 A1
(43) Pub. Date: Feb. 23, 2017

(54) SYSTEMS METHODS AND DEVICES FOR BRAIN HEALTH ASSESSMENT

(71) Applicant: COGNICITI INC., Toronto (CA)

(72) Inventor: Michael MEAGHER, London (CA)

(21) Appl. No.: 14/928,548

(22) Filed: Oct. 30, 2015

Related U.S. Application Data
(60) Provisional application No. 62/206,463, filed on Aug. 18, 2015.

(51) Int. Cl. G09B 5/00; G09B 5/02; G09B 19/00

(52) U.S. Cl. CPC G09B 5/00; G09B 19/00; G09B 5/02

(57) ABSTRACT

Methods and systems are provided in relation to a brain assessment system. A system is provided, comprising: an interface server that hosts a client site or application for establishing a communication interface connection to one or more client devices to receives test-taker identification information and an electronic indication of consent to collection of test data, and send a software and device request signal to check for software and device compatibility, wherein the interface server generates and transmits a test-taker token and a session ID token after validation of the test-taker identification information; a test server for a brain assessment tool that receives the test-taker token and a session ID token and after validation generates an electronic brain testing instance for a client device to compute brain testing results, the electronic testing instance having a test ticket identifier token for the session ID; the interface server monitoring input components of the client device to detect test response times for the electronic testing instance; the interface server tuning the test response times and the brain testing results based on the software and device compatibility and processing times; the test server computing a test report based on normalization of the brain testing results to provide a score relative to adults of similar gender, education, and age; and one or more data storage devices to store the brain testing results, the test ticket identifier token, the session ID, and the test-taker identification information.

### FIELD

The present disclosure generally relates to the fields of cognitive assessment and computing.

### INTRODUCTION

Supervised cognitive assessment requires a doctor or other health care provider to administer the assessment. This requires contact between patient and doctor, such as a visit to the doctor's office, which may consume resources unnecessarily.

### SUMMARY

In accordance with a first aspect, a brain assessment system is provided, comprising: an interface server that hosts a client site or application for establishing a communication interface connection to one or more client devices to receives test-taker identification information and an electronic indication of consent to collection of test data, and send a software and device request signal to check for software and device compatibility, where the interface server generates and transmits a test-taker token and a session ID token after validation of the test-taker identification information; a test server for a brain assessment tool that receives the test-taker token and a session ID token and after validation generates an electronic brain testing instance for a client device to compute brain testing results, the electronic testing instance having a test ticket identifier token for the session ID; the interface server monitoring input components of the client device to detect test response times for the electronic testing instance; the interface server tuning the test response times and the brain testing results based on the software and device compatibility and processing times; the test server computing a test report based on normalization of the brain testing results to provide a score relative to adults of similar gender, education, and age; and one or more data storage devices to store the brain testing results, the test ticket identifier token, the session ID, and the test-taker identification information.

In accordance with another aspect, the brain assessment system further comprising a storage manager for a plurality of customer data storage devices linked to a corresponding plurality of customer identifiers, wherein the interface server receives a customer identifier from a client device and the storage manager triggers storing based on the customer identifier in a corresponding customer data storage device of the brain testing results, the test ticket identifier token, the session ID, and the test-taker identification information for the customer.

In accordance with another aspect, the brain assessment tool is based on the examination of memory, attention, and executive function and the score is generated as a combination of different test results and data transformations provided by different tests of the electronic testing instance.

In accordance with another aspect, the score may be filtered to include sub-scores that may link to different cognitive functions or ailments.

In accordance with another aspect, the score is updated and tracked over time using the test-taker identification information and learning results tuning processes to provide benchmarking.

In accordance with another aspect, the normalization of the brain testing results is based on a comparison to a database of test results.

In accordance with another aspect, the test server normalizes brain testing results based on previous brain testing results.

In accordance with another aspect, the test server receives information from previous brain testing results from one or more remote computing devices.

In accordance with another aspect, normalization of the brain testing results includes normalization based on at least one of device characteristics and network characteristics.

In accordance with another aspect, the test server is configured to automatically generate suggestions for improvement of areas tested in where test results scored below a predefined threshold.

In accordance with another aspect, an interface server sends and/or receives information to one or more computing systems associated with one or more healthcare providers.

In accordance with another aspect, the brain assessment system further comprises a test modification module that modifies the electronic testing instances when a determination is made identifying repeated test taking by the test-taker.

In accordance with another aspect, the score is sent to a healthcare provider and/or user device.

Many further features and combinations thereof concerning embodiments described herein will appear to those skilled in the art following a reading of the instant disclosure.

### DESCRIPTION OF THE FIGURES

In the figures,

FIG. 1 is an example block schematic diagram of a brain health assessment system according to some embodiments.

FIG. 2 is another example block schematic diagram of a brain health assessment system implemented using two servers according to some embodiments.

FIG. 3 is a screenshot illustrating the four tasks together according to some embodiments.

FIG. 4 is a screenshot illustrating a screen where various information is requested in the form of a questionnaire, according to some embodiments.

FIGS. 5-7 are screenshots of instructions provided in relation to the spatial working memory task, according to some embodiments.

FIGS. 8-11 are screenshots of instructions provided in relation to the Stroop task, according to some embodiments.

FIGS. 12-17 are screenshots of instructions provided in relation to the Face-Name association task, according to some embodiments.

FIGS. 18-20 are screenshots of instructions provided in relation to the trail marking task, according to some embodiments.

FIG. 21 is a screenshot of instructions provided in relation to a second spatial working memory task, according to some embodiments.

FIGS. 22A and 22B are screenshots of test results provided to a test taker, according to some embodiments.

FIG. 23 is a schematic diagram of computing device according to some embodiments.

### DETAILED DESCRIPTION

Life expectancy is increasing globally and the older adult population is rapidly growing. As age is a strong risk factor for cognitive decline, the need for cognitive screening is likely to rise proportionately. With increased access to computers and the Internet, particularly among older adults, interactive network-based (e.g., web-based) cognitive assessments that identify individuals in need of further evaluation have become more feasible and have the potential to be extremely useful.

An unsupervised (e.g., self-administered) network-based (e.g., on-line) cognitive screening tool may be provided. In some embodiments, the tool may be used for middle-aged and older adults. The tool may be provided in the form of various systems, devices, methods, and non-transitory computer readable media. Some brain health assessments or tests require trained professionals to administer and/or score the assessments or tests (e.g., supervised tests) which may inefficiently use health care provider and patient time and resources. Some tests may not provide reliability data for composite scores or individual subtests.

In some embodiments, a psychometrically valid, un-supervised, reliable, and easy-to-use, self-assessment computing tool is provided. The tool can be used, for example, for a variety of applications. For instance, the tool may facilitate individuals' determination of whether or not they should raise concerns about memory with their primary care provider. In some embodiments, the tool may be used to establish (and/or compare against) the range of normal performance by measuring of cognitive abilities known to recruit brain regions affected by aging and/or by early cognitive disorders.

Region-specific brain changes in normal aging predominately affect the prefrontal cortex and medial temporal regions including the hippocampus with neuropathological aging typically associated with even greater changes in medial temporal structures. Both of these brain regions play an important role in higher level cognitive processes. The prefrontal cortex supports strategic aspects of memory and attention, including working memory or holding information ‘in-mind’ to guide decisions, actions and executive attention, such as interference control and cognitive flexibility The hippocampus supports memory processes such as binding information together to form an accurate representation.

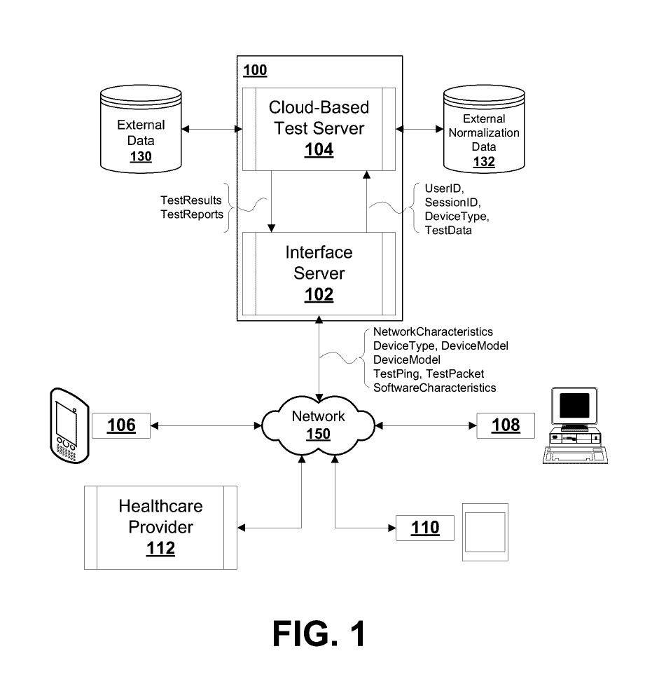

FIG. 1 is an example block schematic diagram of a brain health assessment system implemented using two servers, according to some embodiments.

In some embodiments, computerized tasks based on clinical and experimental data structures may be utilized to in relation to conducting various tests. The results from the tests may be processed, and tests may be selected where test results determined to be sensitive to subtle cognitive changes associated with aging and age-related cognitive disorders. For example, tests may be associated with experimental results in accordance with some embodiments. Experiments may be conducted to validate and determine various relationships and/or correlations between test data, age, education level, etc. These tests may be administered in an unsupervised fashion by a brain health assessment system 100.

The brain health assessment system 100 may implement various functions associated with an unsupervised brain test. For example, the brain health assessment system 100 may be configured to perform various computing operations to implement an unsupervised brain test, such as:
(1) collecting data (e.g., through a survey or a questionnaire) providing a first set of input (e.g., demographic information), the data being used for example, for normalization (e.g., relative to age, relative to education);
(2) performing various brain tests to track various characteristics of a user's performance, for example, performing tests associated with shape matching, object recognition, visual/coordination related exercises, etc.;
(3) processing results from the brain tests and conducting various operations of data transformation and analysis to provide, for example, normalized data having regard to the first set of input; and
(4) generating one or more output scores (and outputting or otherwise making available the output scores as tangible results), the one or more output scores being used for various applications, such as indicating to a user a cognitive test score indicative of brain health, that the user should consider seeking treatment, that the cognitive results have improved or deteriorated over a duration of time (e.g., a predetermined period of time), and so on.

The tests may be arranged by the system 100 in a battery of tests that may be designed to be conducted in an unsupervised fashion (e.g., without an external observer or referee or test administrator), and may have a short duration (e.g., around 20 minutes). Such a battery of tests may generate data which may be processed to provide a useful set of data results that may be benchmarked or standardized or normalized based on various factors (e.g., socio-economic factors, device factors, a combination thereof). A potential benefit to providing an unsupervised test may be that the test may be convenient for an individual to use with a personal computing device (e.g., at a computer through a suitable interface 108, using a mobile device through a suitable interface 106, on a tablet through a suitable interface 110) without the requirement for a medical professional to be present or a medical professional to review and/or analyze the test scores. The interfaces may be connected through a network 150, for example, the Internet or various types of intranet. Various outputs may be provided by the system 100 as tangible results.

These outputs may be provided in the form of scores, ranges, designations, Boolean variables, etc. The outputs may be provided in aggregate form or as individual results, and may be processed to provide standardized (e.g., standardized based on demographics, age, gender, group, location, device input type, connection speed, latency, browser) and/or normalized scores (e.g., based on various weightings, distributions). The outputs may be provided as absolute outputs or relative outputs (e.g., relative to a population, relative to data collected from individuals having a particular disease, relative to others of a similar socio-demographic profile).

In some embodiments, the system 100 is configured to connect with various external systems, for example, healthcare provider device 112, or external data sources such as external data 130, and/or external normalization data 132. These external systems may be utilized to provide information to and/or communicate with the system 100. For example, test results/testing data may be shared with healthcare provider device 112, an alert may be provided to healthcare provider device 112 if a particular trigger is triggered (e.g., a below-average score for an individual triggers an electronic alert), etc.

The system 100 may be implemented such that the interface server 102 and the test server 104 are provided as separate devices. The interface server 102 may be configured to communicate with various interfaces 106, 108, 110 in administering and/or otherwise providing testing functionality and/or features, such as implementing an electronic test using the input/output (e.g., keyboard, mouse, joystick, touchscreen, microphone, speakers, vibrations, touch, gestures, proximity) and/or display capabilities (e.g., electronic display screen, electronic ink, auditory cues) of the computing devices associated with 106, 108 and 110.

The interface server 102 may be configured, for example, to perform various functions, such as hosting a client site or application for establishing an optimized communication interface connection to one or more client devices (e.g., through interfaces 106, 108, 110) to receive test-taker identification information (e.g., name, address, location, device type, email address, educational level, gender, physiological details) and/or an electronic indication of consent (e.g., through clicking on a checkbox, presenting of various consent forms) to collection of test data. In some embodiments, information may be retrieved automatically from various data stores and/or user accounts or profiles residing on the device. The interface server sends a software and device request signal to check for software and device compatibility, functionality and other software and device attributes. Example attributes relating to test data exchange may include network protocol, communication protocol, communication type, etc. The interface server may use test-taker identification information to perform an age check for the test-taker. The interface server may send a test-taker token (including user ID) and a session ID token to test server.

The interface server 102 may also be configured to transmit (e.g., send, communicate) a software and device request signal to check for software and device compatibility functionality and other software and device attributes, where the interface server 102 generates and transmits a test-taker token and a session ID token after validation of the test-taker identification information. The test-taker token and the session ID token may be generated, collected, maintained, updated, validated, and/or otherwise utilized to track various aspects of testing, such as the number of times a user has taken a test, incomplete tests, etc. These aspects may be tracked in a user profile, for example, and may be utilized in processing the test results for a particular test (e.g., a user's results for a particular test may be processed having consideration for a potential skewing effect that the user's familiarity (e.g., caused by muscle memory, anticipation, practice improvements) with the testing methodology.

In some embodiments, the interface server 102 may also be configured to track device type (e.g., laptop, tablet, touch laptop, mobile device, smart phone), device functionality (e.g., touchscreen availability, mouse availability, keyboard availability), device performance (e.g., available memory, hard drive read/write speed, screen refresh rate, screen response time, input/out device type, input/output device characteristics), network performance (e.g., latency, packet loss, data corruption), and so on. This software and device data may be used to process the test results to derive cognitive score and so on. Different types of devices with different functionality and other software and device attributes may result in variations between test results that relate to the device or software and not the cognitive ability or performance of the test-taker. The software and device attributes enable the test results to be adjusted or tuned depending on software and device attributes to increase accuracy of cognitive assessment and provide a device or software independent assessment.

A test server 104 may be provided and configured to implement a brain assessment tool, the test server 104 receiving the test-taker token (e.g., a username, a user identifier) and a session ID token (e.g., a flag, a variable, a count, session characteristic information) and after validation (e.g., checking a database to determine that the user is indeed this user), generates an electronic brain testing instance. The electronic brain testing instance may provide testing, for example may be based on the examination of memory, attention, and executive function of the test-taker.

The electronic brain testing instance may be provided as an interface to a client device (e.g., a laptop, a desktop, a mobile device, a smart phone, a tablet) to compute a brain testing results, the electronic testing instance having a test ticket identifier token for the session ID.

The system 100 (or corresponding process) may provide an interface 106 or device application for installation or execution on computing device. The interface 106 may receive the electronic brain testing instance from test server 104 (with a processor and a memory that stores the electronic brain testing instance and the test-taker token, and session ID token). That is, the test server 104 may transmit the electronic brain testing instance to the interface 106. The transmission may trigger the interface 106 to cause the display of the electronic brain testing instance on the computing device and enable a connection to the test server 104 over a network.

The interface server 102 may be configured for monitoring input components of the client device to detect test response times for the electronic testing instance. As different input hardware and software may have different processing times which may impact test result interpretation and calculation, the interface server 102 may also tune the test response times and the brain testing results based on the software and device compatibility and processing times. For example, such tuning may take into consideration a potential for the skewing of results, especially where differences in device characteristics may be a factor in causing variability of results for a test taken by a particular user (e.g., a slow network connection could lead to a false positive reading of a poor test result). Similarly, a touch screen may be utilized for a quicker response relative to other devices. There may be differences related to the same type of technology implemented using different components and/or designs (e.g., not all touch screens are made the same).

The test server 104 may be configured to then compute a test report based on normalization of the brain testing results to provide one or more scores relative to adults of similar gender, education, and age; and the brain testing results may be stored on one or more data storage devices. Scores may be generated as a combination of different test results and data transformations provided by different tests of the electronic testing instance.

In some embodiments, the one or more storage devices also store the test ticket identifier token, the session ID, and the test-taker identification information. Various assessments may be based on the examination of memory, attention, and executive function and one or more scores may be generated as a combination of different test results and data transformations.

The score may be filtered to include sub-scores that may link to different cognitive functions or ailments and/or updated and tracked over time to provide benchmarking. As an example, testing may be conducted with a number of participants over one or more (e.g., three) iterations of test development. Such testing may be conducted where, for example, a first iteration may involve testing participants in a laboratory under direct observation to ensure that they understand task instructions and respond appropriately.

In some embodiments, remaining iterations may involve participants taking the test from their own homes or otherwise in an unsupervised manner. In some embodiments, after one or more iterations, tasks may be adjusted to help with or ensure that response properties and distributions are appropriate. For example, various networking properties, response time properties, software attributes, hardware attributes, device attributes, session ID, user ID, etc., may be tracked and analyzed to determine how these properties may skew and/or otherwise influence results, and these factors can be corrected for, through for example, processing of the results to standardize, adjust, tune, and/or to normalize the results.

In some embodiments, participants may be adults age 50 and older (in some cases, 40 and older, or other suitable age ranges) and may be recruited via advertisements, clinical trials, and/or from participant and market-research databases. Participants may be selected, identified, grouped, evaluated, or treated according to one or more characteristics, for example, demographic characteristics such as gender, age, education, medical condition, cognitive ability, and ethnicity. For example, a normative sample representative of the North American population may be recruited for participation. In one embodiment, participants may receive no compensation, for example, monetary compensation. Recruitment may be facilitated, for example, by monetary compensation, if difficulty is encountered in recruiting individuals.

In some embodiments, participants may be requested to provide and/or may provide consent and/or a medical history and/or cognitive screen, for example, by telephone. In one embodiment, said participants may receive communication, for example two e-mail messages one week apart that contain instructions and/or links for completing the on-line test in their own homes and/or unsupervised.

In some embodiments, a participant may take a test only once, or more than once. If the same test-taker takes the test multiple times the results may be adjusted to factor in learning of the tests. In one embodiment, a test server 104 may present, allow to be presented, and/or enable the presentation of the same or an alternate version of a task/test upon presentation to a participant that may have been previously presented with one or more tests. In some embodiments, participants who complete the test twice may receive either the same or an alternate version on the second occasion. In some embodiments, there may be four test versions that are counterbalanced across test occasions and used approximately equally often.

The brain health test as provided by system 100 may have applications across various industries. For example, the brain health test may be utilized in the context of pharmaceutical research and/or work conducted by clinical research organizations, where various issues may arise when conducting clinical trials for drug development and testing that target to early state of various problems (e.g., cognitive decline), which may require a determination before users have otherwise noticeable symptoms (e.g., before caregivers identify a sign of problem as a preventative or early intervention).

A potential deficiency with testing systems and apparatuses is that many such systems provide indications that are late in the decline of the individual (e.g., Alzheimer's drugs are brought in late and may encounter difficulty in treating the individual). There may be challenges, especially with clinical trials, where trials are delayed due to the difficulty of identifying clinical participants. These delays may have significant cost (e.g. $1M per day), and are especially apparent where there is a long delay (e.g., a 9 month delay). For example, a traditional approach has been to place ads in newspapers and TV looking for volunteers for trials, sending the individuals into a facility to see if they fit criteria (geographic area, age, education, gender, medical history). A high average cost per volunteer is encountered by such an approach (e.g., $15K), a high drop out rate may be encountered, (e.g., over 50%), and there may be high costs per retained persons (e.g., $40K), especially in studies involving significant numbers of individuals (e.g., 4000 people).

The brain health test provided by the system 100 may, for example, be used to identify early-stage cognitive decline candidates, and also to provide various support and/or treatment to aid individuals as they age. The brain health test may be used, for example, to attract and identify people who are healthy with early stage symptoms to build a pro-active model for testing, which may then be utilized to build a database of people that may be “hot leads” for trials. Iterative approaches using the brain health test may be utilized to further refine and/or track decline over a period of time, potentially suggestive of individuals who may be stronger candidates for various clinical trials and/or treatments. The brain health test may also be utilized, for example, in the context of clinical validation, where people diagnosed in a research or hospital setting and may be requested to take the brain health test. If the results are sufficiently sensitive and/or specific, the brain health test can be utilized as a diagnostic tool and identify ailments.

For example, there may be various drugs under development (e.g., in the pipeline) or under consideration (e.g., for off-label uses) and if these drugs are shown to have various beneficial effects, such as slowing brain ailments or the decline of cognitive function, an individual may be identified as a candidate for receiving such a treatment.

The brain health test may be utilized advantageously to identify individuals before outward symptoms occur and may allow drugs to be targeted for individuals before physical symptoms appear, potentially detecting and/or providing treatment at an early stage before symptoms occur where damage may be at a lower level and potentially easier to repair and/or prevent. Individuals potentially requiring treatment may be identified for inclusion into various clinical trials (e.g., phase 2 and 3 trials). An unsupervised test may be advantageous from various perspectives, where it may be important to reduce the expense and time required to undergo the test, relative to supervised tests.

However, such tests may need to be sufficiently sensitive such that the tests are able to identify problems that may otherwise be difficult to detect (e.g., minor or very minor problems). For example, the brain health test may be used to identify aspects related to mild cognitive impairment (e.g., a state between a healthy brain and a brain with dementia) and identify a state that may still be healthy but detected early based on genes, etc. they may not be able to remember names, places, etc. that may turn into dementia. Such persons may be identified with mild cognitive impairment before there is an otherwise significant impact on their individual lives. As noted, it is important that the test results (factoring in such sensitivities) be consistent across various types of devices and software used for the testing regardless of variations between devices and software.

The brain health test may also be used in the context of clinician and home-care networks, for example, identifying potential indications of early-onset mild cognitive decline. For example, the brain health test may be used as an “early warning screen” for seniors in their homes, communities, residences. The indications may be helpful, for example, as these facilities adapt and/or make decisions relating to the treatment and care of people with various cognitive problems (e.g., considering whether the individual can still perform certain functions). The brain health test may be provided in various consumer-friendly formats and on various types of devices, such as mobile devices 106, computer desktops 108, tablets 110, etc., and may be utilized by a wide range of individuals of different ages, etc. The test data may, in some embodiments, be centrally stored and/or collected such that population-level and/or sub-population level data may be aggregated and/or analyzed (e.g., through data-mining and data processing techniques).

The brain health test, in some embodiments, can be conducted over a period of time and scores and/or results may be tracked. For example, individuals can retake test after taking drugs and load results into a database for monitoring data. There may be various communications with third party system interfaces to, for example, enable data transfers to various servers where test information may be provided to and/or collected in various external databases. In some embodiments, this information may be anonymized and identifiers may be provided based on current test taker ID, session ID, etc., or hashed versions of the same. Where there may be various clinical trials being implemented, the system 100 may link test takers to clinical trial ID assigned by customer.

The linkages may also be utilized in various scenarios, for example, for some insurance reimbursement schemes, a linkage may need to be made to an electronic medical record so that information (e.g., scores, sub-scores) can be viewed by different healthcare providers. For example, the information may flow into a community care access center database, where the information may be utilized in the context of nursing services provided to individuals, etc. Patients may receive an identifier token from a community care system which they may input at the time of taking a test, and thus may, in some embodiments, avoid providing otherwise identifiable information into the brain health test system itself (e.g., names, ages, conditions may be stored on external databases).

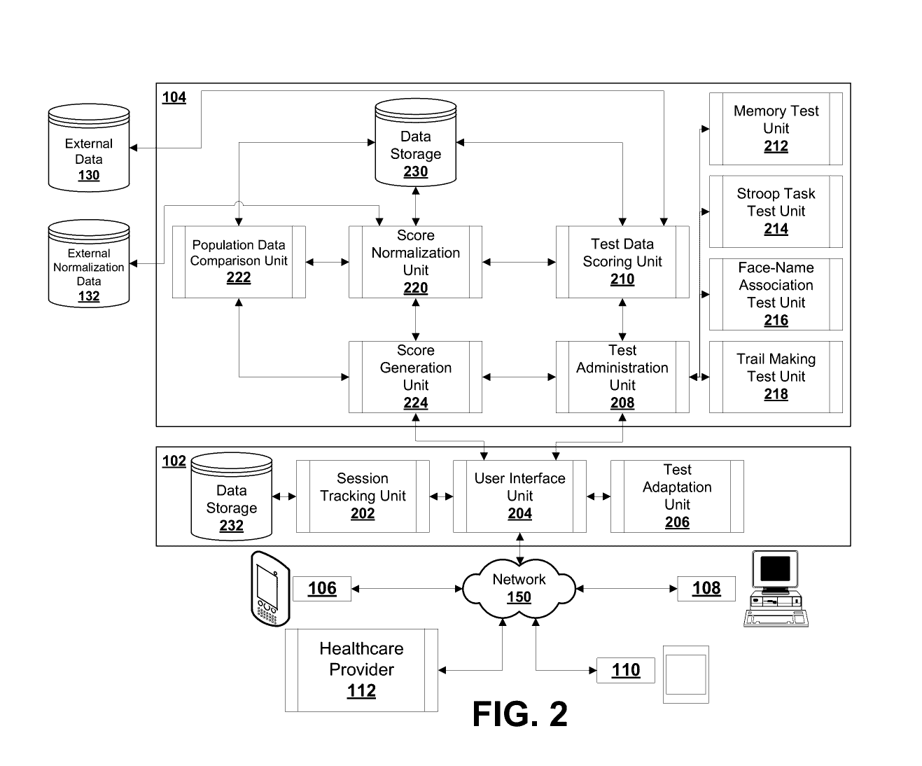

FIG. 2 is another example block schematic diagram of a brain health assessment system implemented using two servers, according to some embodiments.

The brain health assessment system 100 may include, for example, a session tracking unit 202, a user interface unit 204, a test adaptation unit 206, a test administration unit 208, a test data scoring unit 210, a memory test unit 212, a Stroop task test unit 214, a face-name association test unit 216, a trail making test unit 218, a score normalization unit 220, a population data comparison unit 222, and a score generation unit 224. The units are provided as examples, there may be more, less, different, and/or alternate units. The units may be implemented in hardware, software, embedded firmware, etc. The units may interoperate with one another in implementing various aspects and features of the brain health assessment. The brain health assessment system 100 may include and/or interoperate with various data storage components, including, for example, data storage 230, data storage 232, external data 130, external normalization data 132, among others. Data storage components can be implemented using a variety of technologies, for example, hard disk drives, solid state disks, redundant arrays of storage media, CD-ROMs, memory, databases (e.g., flat databases, relational databases, non-relational databases, text files, extended markup language files, spreadsheets), among others.

In some embodiments, some features are provided using a server/workstation model, a centralized data center, a decentralized data center, a set of virtualized resources, a set of distributed networking resources (e.g., a “cloud computing” implementation), etc. Various topologies are possible and are not limited by this disclosure. For example, the brain health assessment system may be provided in two separate servers, an interface server 102, and a test server 104. In other embodiments, the interface server 102, and the test server 104 are provided on a same server.

The interface server 102 may include, for example, the session tracking unit 202, the user interface unit 204, the test adaptation unit 206, and data storage 232.

The interface server 102, through the user interface unit 204 may be configured to receive various types of demographic input data, such as an individual's age, education, memory concerns, health history, mood, geographic location, gender, etc. In some embodiments, the user interface unit 204 may be configured to receive such information from a healthcare provider's systems 112 directly. This information may be used in various aspects of testing; for example, dynamically adjusting the scoring, validating whether a user is a candidate for testing, adaptively modifying testing, etc. Information related to the user's connection and testing apparatus may also be stored, such as device information, network characteristics, software in use, hardware functionality, etc. In some embodiments, different information may be solicited depending on the particular type of device a user may be interfacing with the interface server 102 with. For example, the interface server 102 may track various data points, such as a user ID (e.g., numeric, based upon an email address), response time, session ID, etc. The User ID may stay the same over multiple visits; and each visit may be linked to a session ID. As the session increases, testing may be adapted to different versions of various tasks and/or tests (e.g., version 1, version 2, version 3) linked to different session IDs.

The user interface unit 204 may also be utilized to provide various graphical displays and/or other types of displays related to test administration (e.g., graphically displaying faces, symbols, objects) and also to receive various inputs from the user (e.g., keystrokes, clicks, touches, gestures, audio).

The test adaptation unit 206 may be configured to provide various functionality in relation to test administration. For example, the test adaptation unit 206 may dynamically adapt testing based on an identification that a user has taken the test before, and the location of various objects should be randomized and/or relocated. Such identification may be based on the tracked session ID and the user ID (e.g., the same user ID may be identified having taken the same permutation of a particular type of test and a different permutation should be chosen). The test adaptation unit 206 may also adapt aspects of test delivery based on, for example, the type of device and/or software utilized by a particular user. Dynamic testing may be utilized in that different tests may be provided to users depending on desired results. The test adaptation unit 206 may track such adaptations, which may be utilized, for example, in normalizing and/or standardizing test results.

Data storage 232 may be utilized to store various interface server 102 related data, such as session IDs, user IDs, historical test adaptations, network characteristics, device characteristics, software characteristics, user validation data, etc.

The test server 104 may include, for example, the test administration unit 208, the test data scoring unit 210, the memory test unit 212, the Stroop task test unit 214, the face-name association test unit 216, the trail making test unit 218, the score normalization unit 220, the population data comparison unit 222, and the score generation unit 224. Other testing units may be included, and the testing units and tests described in various embodiments are provided as illustrative, non-limiting examples. The test server 104 may be implemented in various ways, for example, using the Microsoft Azure™ cloud computing platform. In some embodiments, test server 104 may be comprised of one or more computers. In some embodiments, each of data storage 230, score normalization unit 220, test data scoring unit 210, test administration unit 208, score generation unit 224, and population data comparison unit 222 may be housed on one or more separate computers.

Data storage 230 may store data, for example, relating to one or more brain testing results, one or more test ticket identifier tokens, identification of one or more sessions, identification of one or more test-takers, one or more test takers; one or more sessions, for example, identification or time of said session; one or more devices, for example, devices engaged with a network 150 and/or an interface server 102; administration of one or more tasks and/or tests; one or more indications of consent to collection of data, for example, collection of test data; one or more test results of one or more tasks and/or tests; aggregation of one or more said test results; one or more test reports; one or more test response times; one or more indications and/or selections made by one or more test-takers; and/or one or more relationships between said data.

The test administration unit 208 may be configured to provide various aspects associated with brain health tests, such as communicating various control instructions to the user interface unit 204 for administrating aspects of tests (e.g., displaying various information, requesting user ID/session IDs). The test administration unit 208, in some embodiments, may be utilized to provide a battery of tests having a plurality of, for example, four, tasks, and/or an option for providing feedback about the program and/or pilot testing and/or related research on the program. For example, the test administration unit 208 may interoperate with various test units, such as the memory test unit 212, the Stroop task test unit 214, the face-name association test unit 216, and/or the trail making test unit 218. The list of tests is provided for illustrative, non-limiting purposes and there may be other, more, or different tests. In some embodiments, one or more tests may be provided more than once to a user. The test administration unit 208 may be configured to receive information from the user interface unit 204 associated with the user's performance in conducting the tasks set out by the various tests, such as reaction time, total time to complete, accuracy, etc. Other information may also be tracked, such as inadvertent inputs, etc.

For example, the test administration unit 208 may be configured to provide 6 exercises to collect input data. The tests may be conducted based on various tasks performed by a user, and some tests may be utilized to assess immediate memory, and some tests for assessing delayed memory.

The test data scoring unit 210 may be configured to receive the testing data from the test administration unit 208 and to generate one or more scores and/or results. In some embodiments, the test data scoring unit 210 may be configured to generate various raw scores based on various aggregations and/or combinations of received inputs and/or information processed from received inputs, such as reaction time, total time to complete, accuracy, etc. These raw scores may be stored in data storage 230 and/or passed to score normalization unit 220 for further processing.

The test data scoring unit 210 may also be configured to associate various other elements of information, such as information retrieved from external data 130, data from data storage 230, and/or data from test administration unit 208, relating to one or more test takers. This associated information may include identification that a user has undergone one or more sessions, time of said session; type of device, network characteristics, type of software (e.g., browser), device functionality, etc. This information may be passed on to the score normalization unit 220 as the information may be utilized to aid in the process of normalizing the results having regard to various associated information.

The memory test unit 212 may be configured to provide functionality associated with a spatial working memory task. For example, the spatial working memory task may require participants to locate multiple pairs of hidden shapes in an array and avoid erroneously returning to previously searched locations.

The Stroop Task test unit 214 may be configured to provide functionality associated with variations of Stroop tests, where attentional control and processing speed are assessed by tracking a user's ability to accurately input responses based on instructions provided and/or visual stimuli. In some embodiments, the visual stimuli may be provided such that aspects of the stimuli are incongruent with instructions, and a user may be tasked with correctly identifying a response in accordance with the instructions. For example, key presses on a keyboard may be tracked and a counting variant of the Stroop task may be provided, where users identified the number of words shown on each trial. The Stroop task may be set up to include “interference trials”, where the number of words was incongruent with the meaning of the word (e.g., the word “three” was written two times).

The face-name association test unit 216 may be configured to provide an associative memory task where a set of faces are shown to the user, with associated names. In some embodiments, faces and names are shown sequentially. The faces are then provided to the user in various orders, and the user may be requested to correctly the name associated with a face or vice versa.

The trail making test unit may be configured 218 to provide a task whereby the user attempts to maintain a current sequence while searching for the next number or letter in the sequence, and may be designed to test the mental flexibility of the user by alternate attention between the two sequences, and processing speed. Users may be provided alternate sequencing numbers and letters in ascending order as quickly and accurately as possible, and the user may be tasked with selecting the correct sequences such that a “trail” is made between the various objects in the sequences. There may be one or more sequences.

The score normalization unit 220 may be configured to process the raw scores to normalize and/or standardize the scores based on various factors. In some embodiments the raw scores may be adjusted based on the presence/absence of specific factors. The factors may include, for example, age range, demographic, education, gender, device, software, network characteristics, number of times a test has been taken, etc. These scores may be “tuned” accordingly, based on the factors identified. For example, results may be normalized to generate and/or determine various types of result outputs, such as a brain health score, a Z-score, a percentile ranking, sub-scores for different brain health factors or ailments such as memory and attention in addition to the overall score, tracked changes in scores over time for an individual.

As each individual test may provide a raw score, algorithms may be utilized to computes a Z-score for each of the tests and an overall score may be determined using, for example, an average of the overall z-score. Z-scores, in some embodiments, may be provided on a scale −5.0 to +5.0 which may be used to translate the scores to a percentile score.

In determining the Z-scores, the score normalization unit 220 may utilize stored data to normalize the raw data based on factors such as age and education and the number of times the user has taken the test (repeat test), among others. Binary determination may be determined, for example, based on historical data from Bell curves and outlier points relating to individuals whose results may lie outside the normal range of the curve. The information may be utilized based on a determined normal range and the outlier points may be indicative of abnormal sections (e.g., a Z score below −2.0). The normal percentage of people who fall into the abnormal zone (2-3%) may be utilized as validation, and the mean and standard deviation may be determined. The determined z-score may indicates where the user resides on various curves and in some embodiments, may be a percentile score based on age and education. The score normalization unit 220 may be configured to average the scores to obtain a composite score, and a threshold value may be used to determine whether the user is within an abnormal or a normal range. Different techniques, norming or normalizing data and/or tests may be applied depending on factors such as different devices, features, software, etc.

The normalization data may be conducted for example, based on information derived from a population data comparison unit 222, external normalization data 132, etc. The score normalization unit 220 may be configured to perform translation between scores, and/or other data sets. For example, in some embodiments, the test may be provided to users within an age range (e.g., 40-89), but scores may be normalized based on various cohorts of age (e.g., 40-45, 46-48). In one embodiment, score normalization unit 220 may process data, for example, and normalize the data according to one or more characteristics, for example, demographic characteristics, such as gender, age, education, medical condition, cognitive ability, and ethnicity. For example, score normalization unit 220 may apply an algorithm to effect normalization. Normalization data may be empirically validated, for example, normative data may be collected from a group of adults chosen to be representative of the general population based on gender, education, and age. Data collected from normalization may be used generate and/or tailor he algorithms used to delivered a percentile score relative to adults of similar age/education, and a yes/no answer to the question “Is my cognitive result in the normal range for my age/education or should I see my doctor?”.

The score generation unit 224 may be configured to generate one or more scores based on the raw scores and/or the normalized/standardized scores. In some embodiments, a single normalized score is provided. In some embodiments, scores are provided at a more granular level, based on tests taken and the range of answers to questions provided. The scores may be provided in relation to a subset of test metrics focused on different aspects, and the results may be stored in data storage 230. In some embodiments, the scores are provided as a comparison against population data, and in some embodiments, the scores are then stored and used to tailor population data for future tests. In some embodiments, a percentile score relative to adults of similar age/education, and a yes/no answer to the question “Is my cognitive result in the normal range for my age/education or should I see my doctor?” is provided to the user.

In some embodiments, the score generation unit 224 may also be configured to provide additional tailored results and/or recommendations based on the generated score. The user may be provided an overall score, with various sub-problems and solutions identified (e.g., identifying that a user is particularly deficient at a set of specific tasks).

For example, if a user is administered the test and results indicated that the user performed poorly in name and face recognition, then the score generation 224 unit may trigger a new tailored results page, that may also include various recommendations (e.g., recommending the downloading of an app that helps the user improve on name and face recognition tasks). There may be various associated training tools, and recommendations may be generated by the system 100 or retrieved from various external data sources 130, such as a community care access center's systems. In some embodiments, recommendations may also recommend various clinical trials, medication, therapy, etc.

In some embodiments, the score generation unit 224 may be configured for generating various testing results, such as test reports based on data relating to one or more test scores and/or one or more normalized test scores. For example, score normalization unit 220 may transmit data relating to one or more normalized test scores to score generation unit 224. In some embodiments, the test report may contain data expressed relative to scores relative to adults of similar characteristics, for example, demographic characteristics such as gender, age, education, medical condition, cognitive ability, and ethnicity. A test report may be generated and provided to the test taker, and one or more reports may also be provided to various practitioners (e.g., having a more detailed set of information). A dynamic personalized action plan may be generated based on the results of the test report and/or other associated information.

In some embodiments, sub-scores may be determined in relation to different cognitive impairments, and variations of reports may be provided dependent on results (e.g., below normal, normal with no memory concerns, normal with memory concerns). Some variations of reports may, for example, include guidance in relation to memory concerns and advice to consult a healthcare professional, and may interface with external healthcare systems. In some embodiments, the score generation unit 224 is configured for automating the evaluation of results. In some embodiments, a degree of impairment may be assessed.

In some embodiments, the score generation unit 224 may also recommend to a user to retake the test after a period of time or immediately, and such results may be monitored. The retaking of tests may be utilized, for example, to more accurately determine that a condition exists and to validate various test results. In some embodiments, a learning algorithm may be applied to adjust the scores. In some embodiments, automatic reminders to re-take the test may be provided dependent on the result obtained by a user.

### Experimental Test Validation

Various experiments were conducted with an implementation of the brain health assessment system 100, according to some embodiments. The system 100 was designed to include various tests associated with tasks that were indicative of measures of memory and executive attention processes known to be sensitive to brain changes associated with aging and with cognitive disorders that become more prevalent with age. Measures included a Spatial Working Memory task, Stroop Interference task, Face-Name Association task, and Number-Letter Alternation task.

Normative data were collected from 361 healthy adults, aged 50-79 who scored in the normal range on a standardized measure of general cognitive ability. Participants took a 20-minute on-line test on their home computers, and a subset of 288 participants repeated the test 1 week later. Analyses of the individual tasks indicated adequate internal consistency, construct validity, test-retest reliability, and alternate version reliability. As expected, scores were correlated with age. In this experiment, the four tasks were loaded on the same principal component.

Demographically-corrected z-scores from the individual tasks were combined to create an overall score, which showed good reliability and classification consistency. These results may be indicative that the system 100 may be useful for identifying middle-aged and older adults with lower than expected scores who may benefit from clinical evaluation of their cognition by a health care professional.

Consistent with these age-related brain changes, it may be known that episodic and associative memory, working memory, and executive attention decline in normal cognitive. Some of these same cognitive changes are also seen in early cognitive disorders.

Based on these age-related changes in the brain and cognition, the investigators selected four tasks of memory and executive attention and modified them to accommodate on-line self-administration:

1. A spatial working memory task was provided that requires participants to efficiently locate multiple pairs of hidden shapes in an array and avoid erroneously returning to previously searched locations. Brain lesion and functional neuroimaging studies have confirmed the essential role of the prefrontal cortex in this type of task.

2. A Stroop task was provided to examine attentional control and processing speed. To accommodate responding by key press, a counting variant of the task was developed in which participants identified the number of words shown on each trial. During interference trials, the number of words was incongruent with the meaning of the word (e.g., the word “three” was written two times). Both the standard and counting variants of the Stroop task show greater interference effects in older relative to younger adults—due to either age-related slowing or reduced inhibitory control—and are sensitive to dementia and frontal lobe damage.

3. A face-name association task was provided as associative memory may be dependent on the integrity of the hippocampus and because the task is sensitive to both normal aging and mild cognitive impairment. Because changes in hippocampal volume occur early in pathological aging including Alzheimer's disease, this measure may be particularly sensitive for distinguishing normal memory changes from those of a more serious nature.

4. A trail making test was provided as the task required by the test is multifactorial, engaging working memory to maintain the current sequence while searching for the next number or letter, flexibility to alternate attention between the two sequences, and processing speed. On this task, participants alternate sequencing numbers and letters in ascending order as quickly and accurately as possible. Older adults show greater difficulty on these tasks compared to younger adults, due to both age-related decline in processing speed as well as age differences in executive cognitive processes. The frontal lobes significantly, although not exclusively, support the cognitive operations involved in this task.

Overall, investigation sought to: (a) assess the feasibility of the platform for test administration; (b) assess the reliability and construct validity of the measures; and (c) obtain normative data that could be used to assist older adults in evaluating their subjective memory concerns. Because the measures were based on specific cognitive tests, it was expected the tests would exhibit good internal consistency, construct validity, and reliability. The investigators expected the tasks to be inter-correlated and, given the selection of two memory tasks and two tasks of executive attention that the tests would load on two separate factors. The study protocol was approved by the Research Ethics Board at Baycrest Centre for Geriatric Care.

Adults age 50 and older were recruited via advertisements and from participant and market-research databases. To evaluate psychometric test properties, the investigators included data from all 396 participants who completed the test on at least one occasion and who did not produce extreme outliers on testing. To calculate normative data, the investigators excluded 35 participants with a self-reported history of medical conditions known to affect cognition (e.g., traumatic brain injury, stroke, mild cognitive impairment, current depression) and/or those scoring below the normal range on a cognitive screening test (i.e., less than 31 on the modified Telephone Interview for Cognitive Status).

The investigators recruited participants with demographic characteristics—including age, sex, and educational attainment—to create a normative sample that was representative of the North American population. Demographic data for the sample are presented in Table 1.

TABLE 1
Sample demographics.

| | 5-year age groups | | | | | | | | | | | | | |
|---|---|---|---|---|---|---|---|---|---|---|---|---|---|---|
| | 50-54 | | 55-59 | | 60-64 | | 65-69 | | 70-74 | | 75-79 | | All | |
| | (n = 39) | | (n = 72) | | (n = 82) | | (n = 57) | | (n = 54) | | (n = 57) | | (n = 361) | |
| Age (mean, SD) | 52 | (1.3) | 57 | (1.4) | 62 | (1.3) | 67 | (1.2) | 72 | (1.2) | 77 | (1.8) | 65 | (8.2) |
| Sex (n, %): | | | | | | | | | | | | | | |
| Females | 24 | (62) | 39 | (54) | 47 | (57) | 31 | (54) | 27 | (50) | 34 | (60) | 202 | (56) |
| Males | 15 | (38) | 33 | (46) | 35 | (43) | 26 | (46) | 27 | (50) | 23 | (40) | 159 | (44) |
| Education (n, %): | | | | | | | | | | | | | | |
| Less than high school | 4 | (10) | 5 | (7) | 5 | (6) | 12 | (21) | 7 | (13) | 8 | (14) | 41 | (11) |
| High school | 8 | (20) | 19 | (26) | 29 | (35) | 16 | (28) | 12 | (22) | 16 | (28) | 100 | (28) |
| University | 18 | (46) | 33 | (46) | 32 | (39) | 15 | (26) | 16 | (30) | 23 | (40) | 137 | (38) |
| Post-graduate degree | 9 | (23) | 15 | (21) | 16 | (20) | 14 | (25) | 19 | (35) | 10 | (18) | 83 | (23) |

Note:
Education is the highest level of education completed.

Most participants received no monetary compensation. Because of difficulty recruiting individuals with less than a high school education, near the end of the recruitment period the investigators offered $75 to improve recruitment in this group. Subsequent analyses indicated that paid (n=9) and unpaid (n=32) participants with less than high school education did not differ on the four targeted test scores, F_{(4,36)}<1 p=0.57, η²ₚ=0.08.

The investigators selected and developed computerized tasks based on existing clinical and experimental tasks sensitive to subtle cognitive changes associated with aging and age-related cognitive disorders. While designing and selecting the tasks, the investigators sought to keep the total duration of the battery at around 20 minutes.

The investigators conducted pilot testing with 140 participants over 3 iterations of test development. The first iteration involved testing participants in the laboratory under our direct observation to ensure that they understood task instructions and responded appropriately. The remaining iterations involved participants taking the test from their own homes. After each iteration, the investigators adjusted tasks as needed to ensure that response properties and distributions were appropriate.

The final tasks were programmed in ASP.NET™, JavaScript™, and Adobe Flash™, and the program was hosted on the Microsoft Azure™ cloud computing platform. This is an example embodiment for illustrative purposes.

Tasks could be completed from PC or Macintosh™ desk-top and laptop computers. Completing the tasks required users to have an Internet connection, a recent version of an Internet browser (e.g., Internet Explorer 7™ or above, Safari™ version 4 or above, Firefox™ version 10 or above, and any version of Google Chromen™), and a recent version of Adobe Flash Player™ (version 10 or above).

Tasks were administered in a fixed order: Spatial Working Memory, Stroop Interference, Face-Name Association, and Letter-Number Alternation. Administration of each task was preceded by detailed instructions showing sample task stimuli. The Stroop interference and letter-number alternation tasks also had practice trials during which feedback was provided for incorrect responses. On these practice trials, errors were immediately identified, and participants were required to make a correct response before proceeding to the next item.

Four versions of each task were developed using different task stimuli (for the Spatial Working Memory and Face-Name Association tasks), different spatial locations (for the Spatial Working Memory and Letter-Number Alternation tasks), and different orders of test stimuli (for the Stroop Interference task).

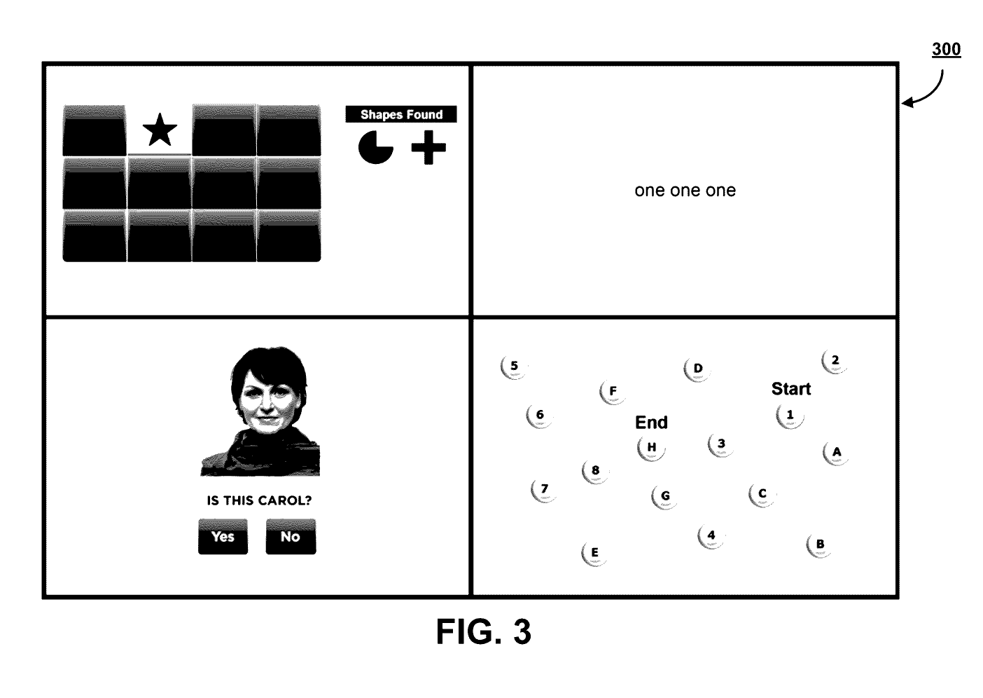

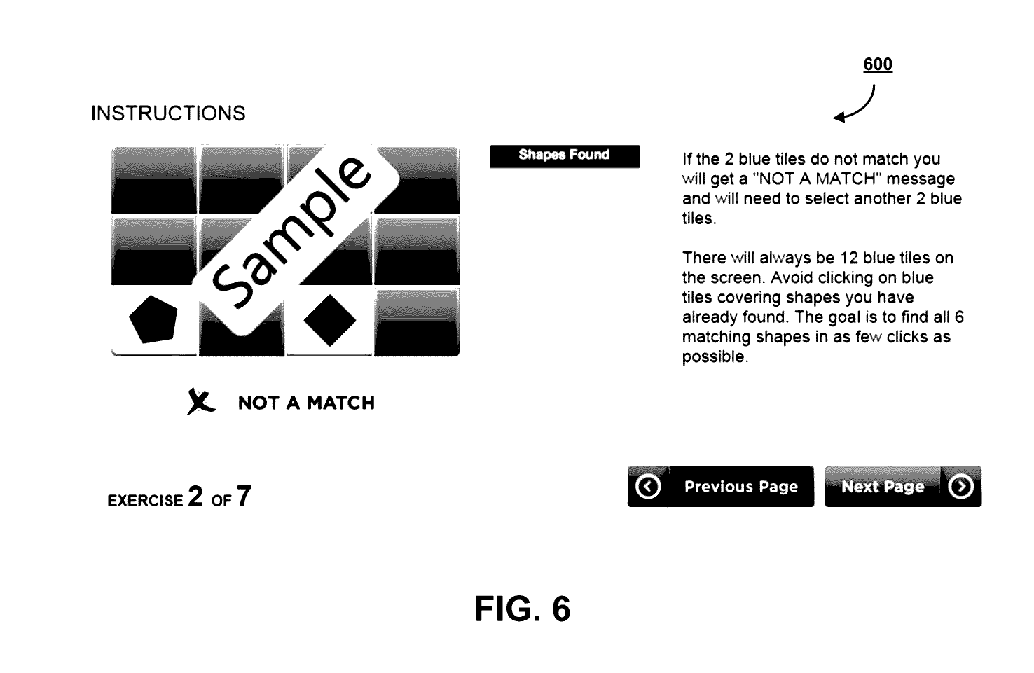

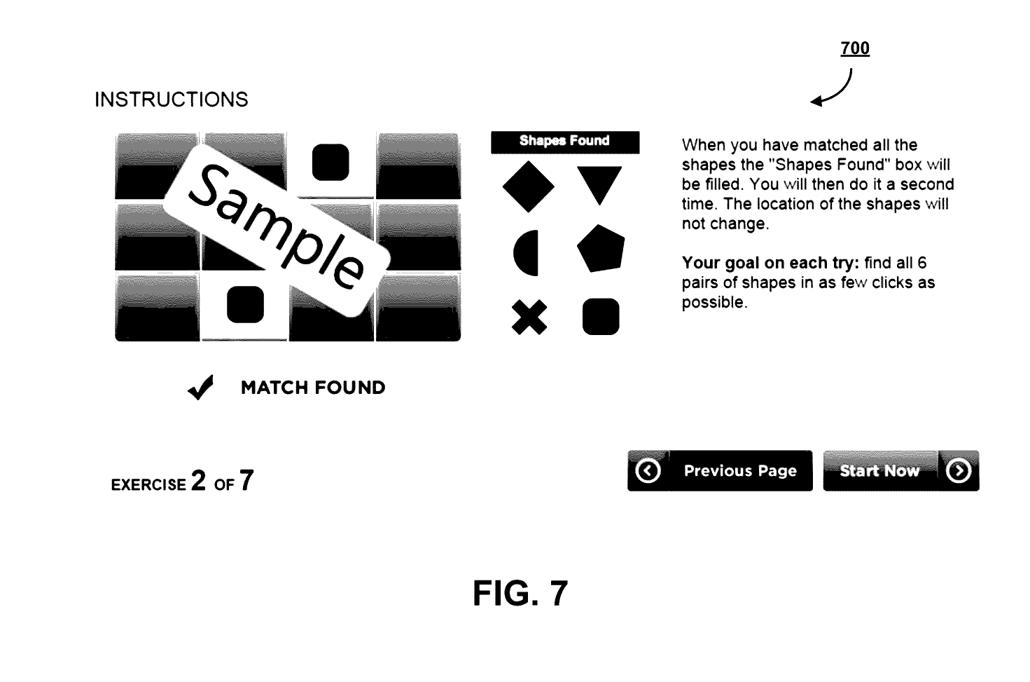

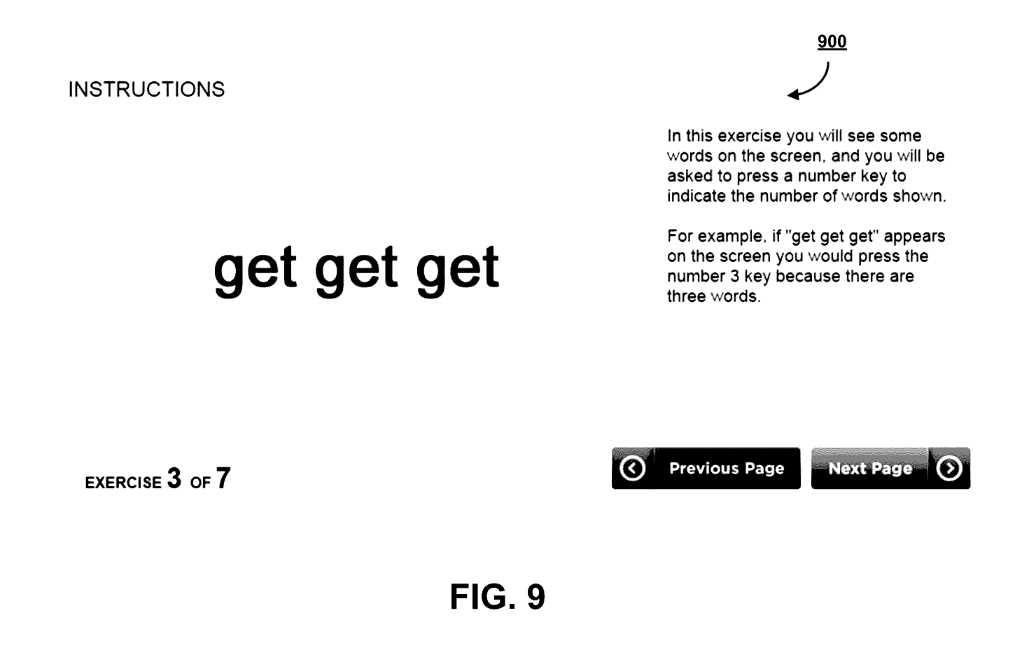

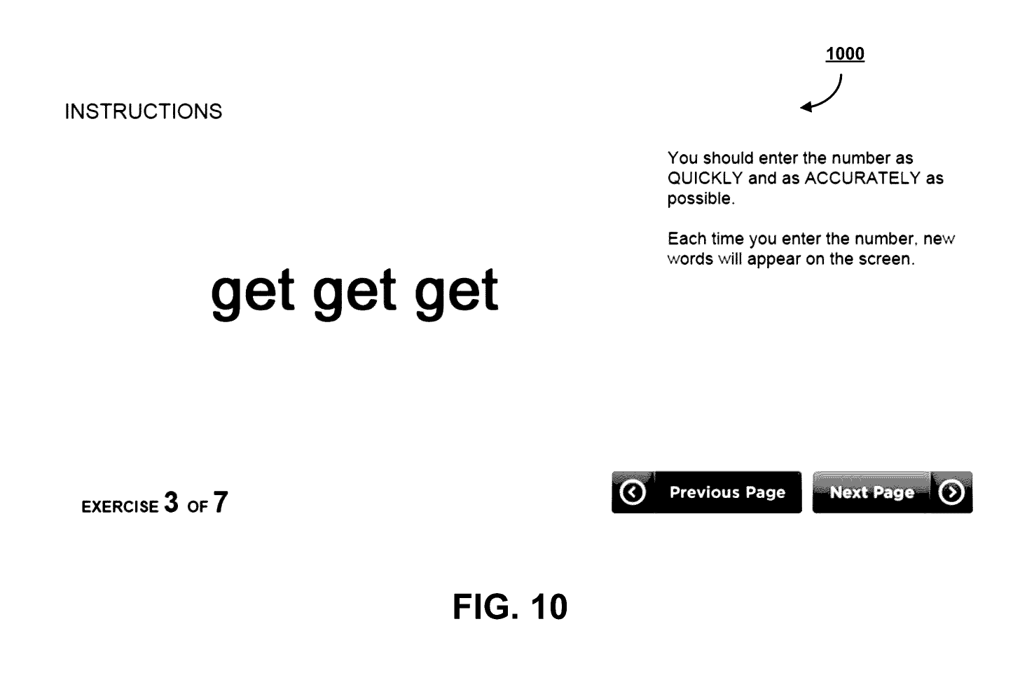

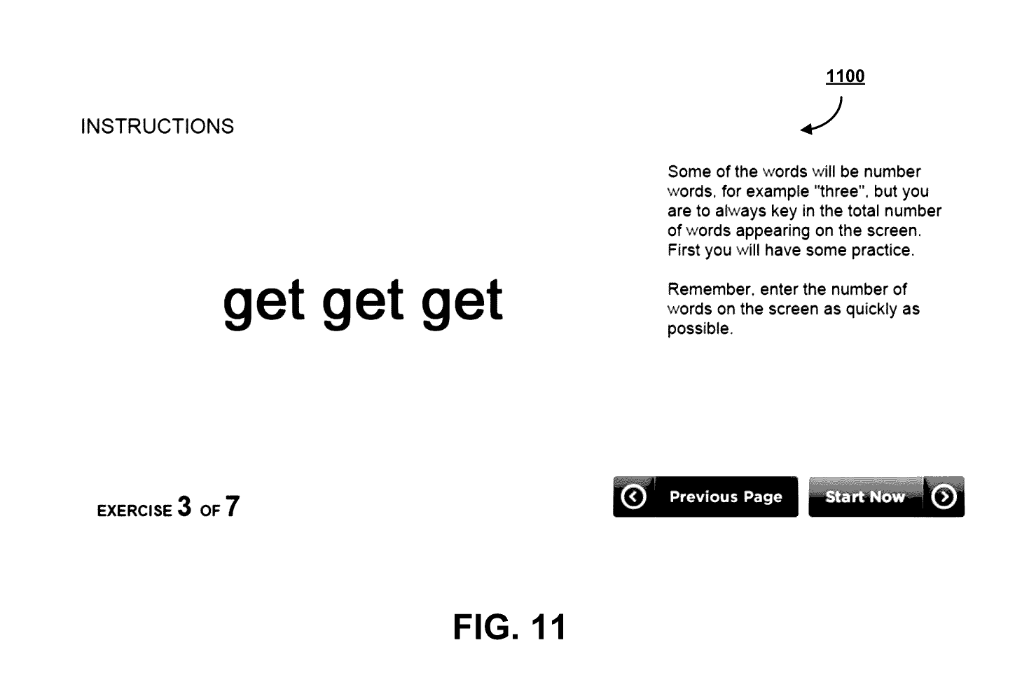

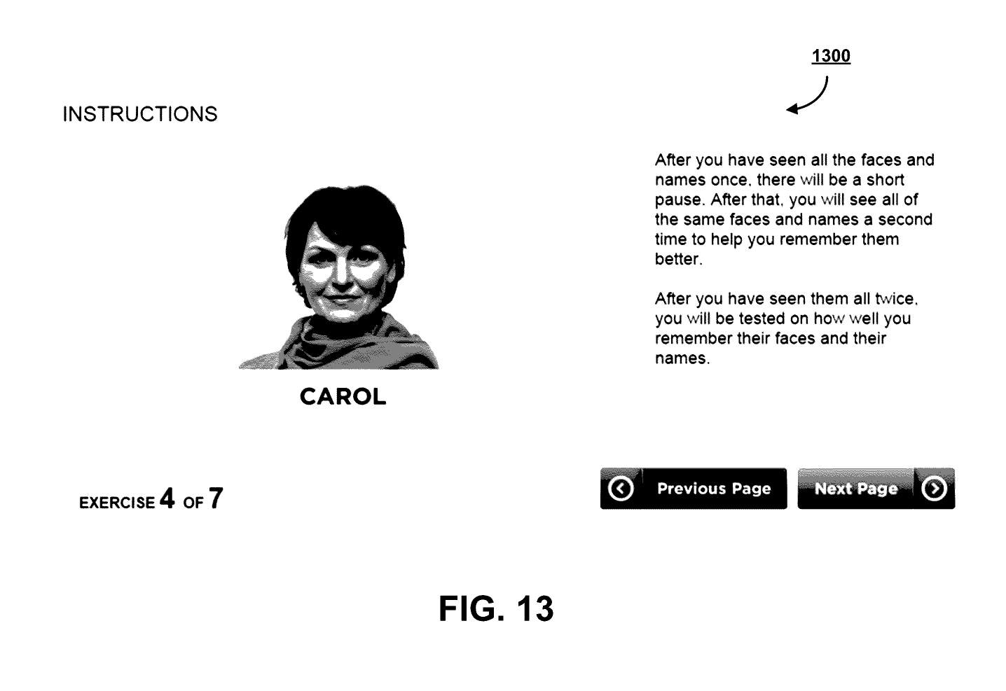

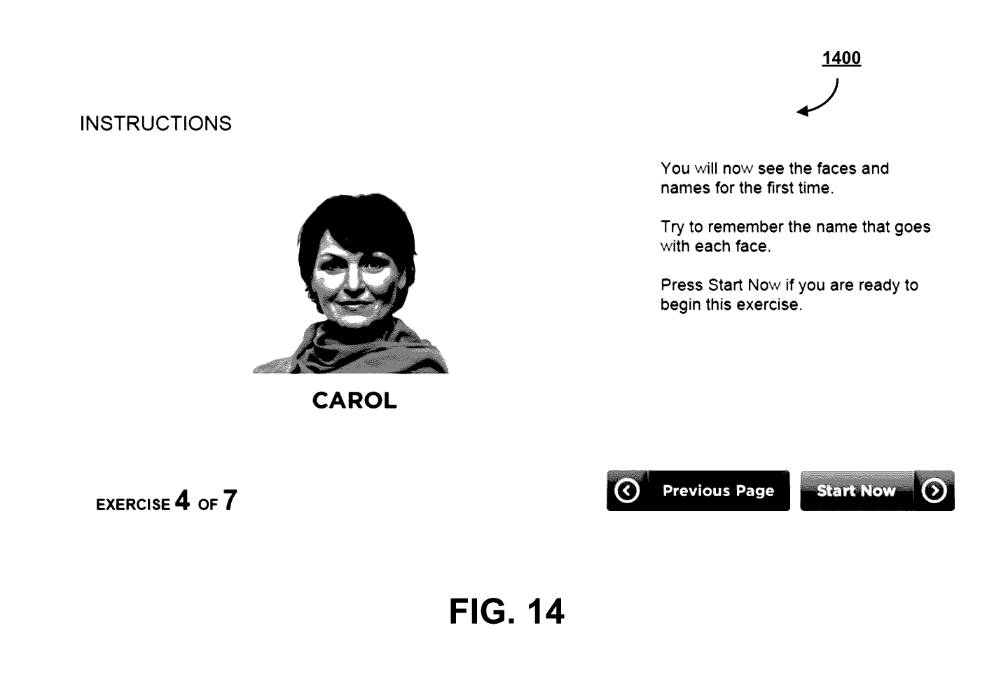

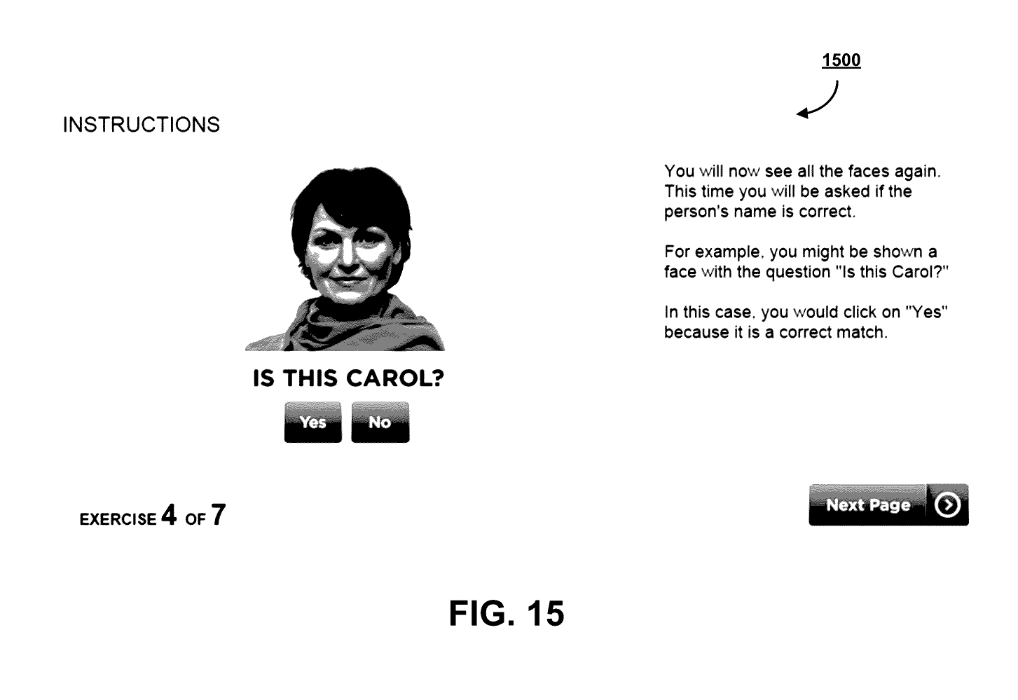

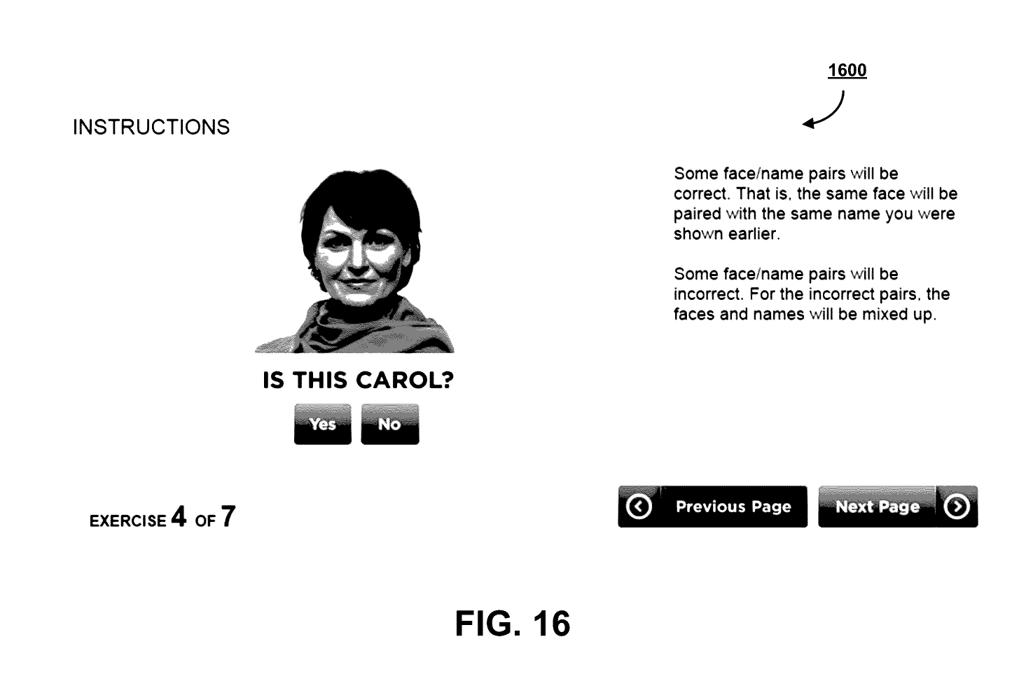

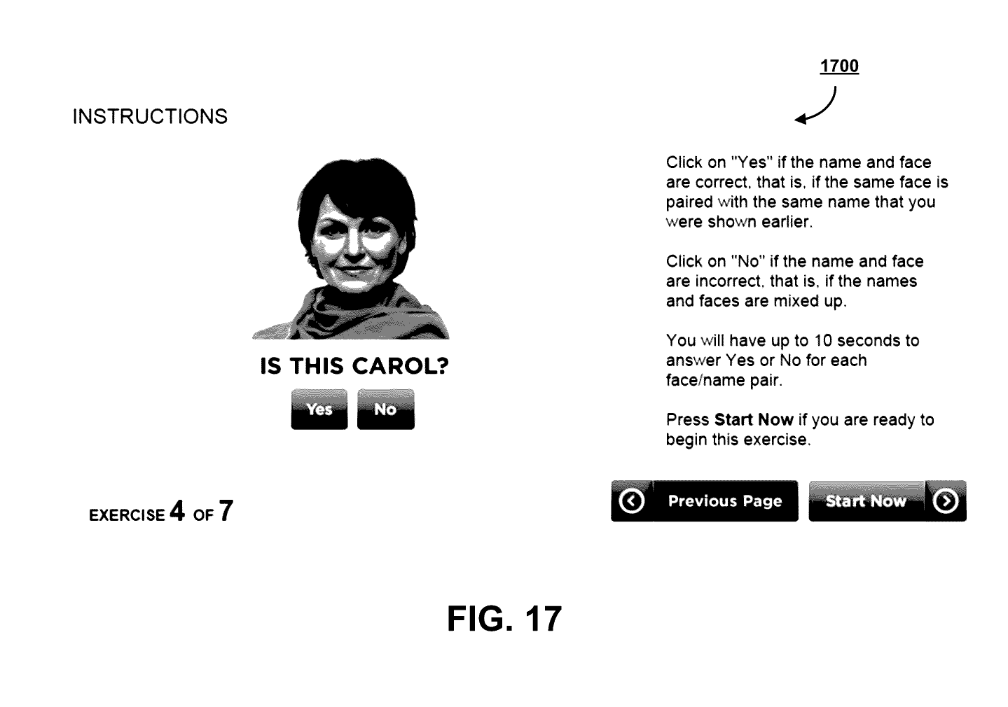

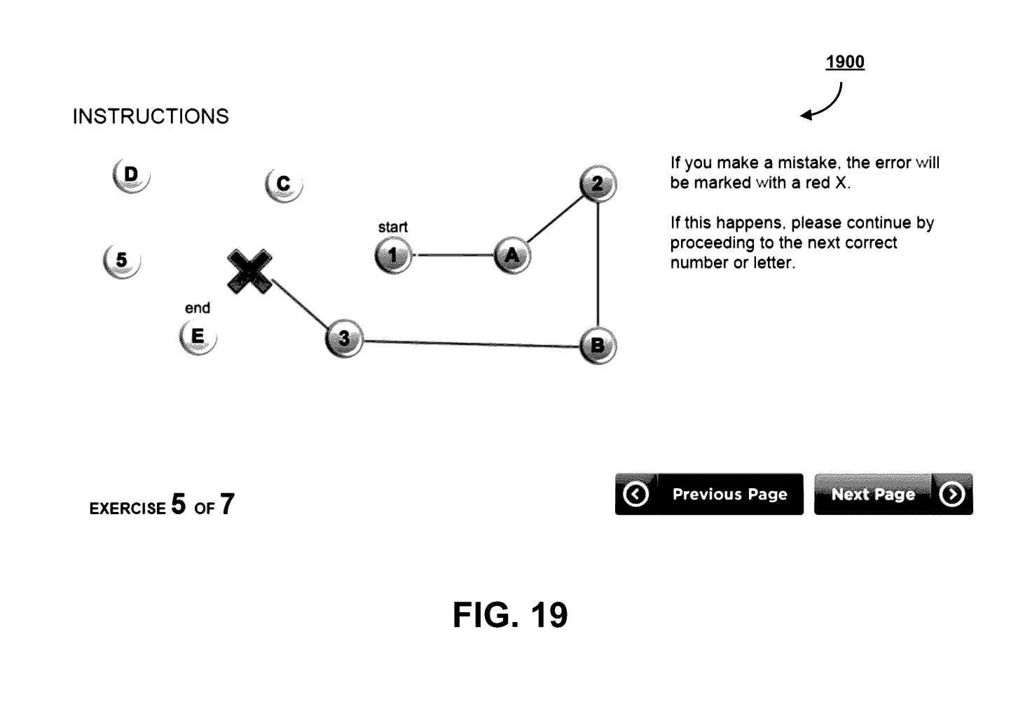

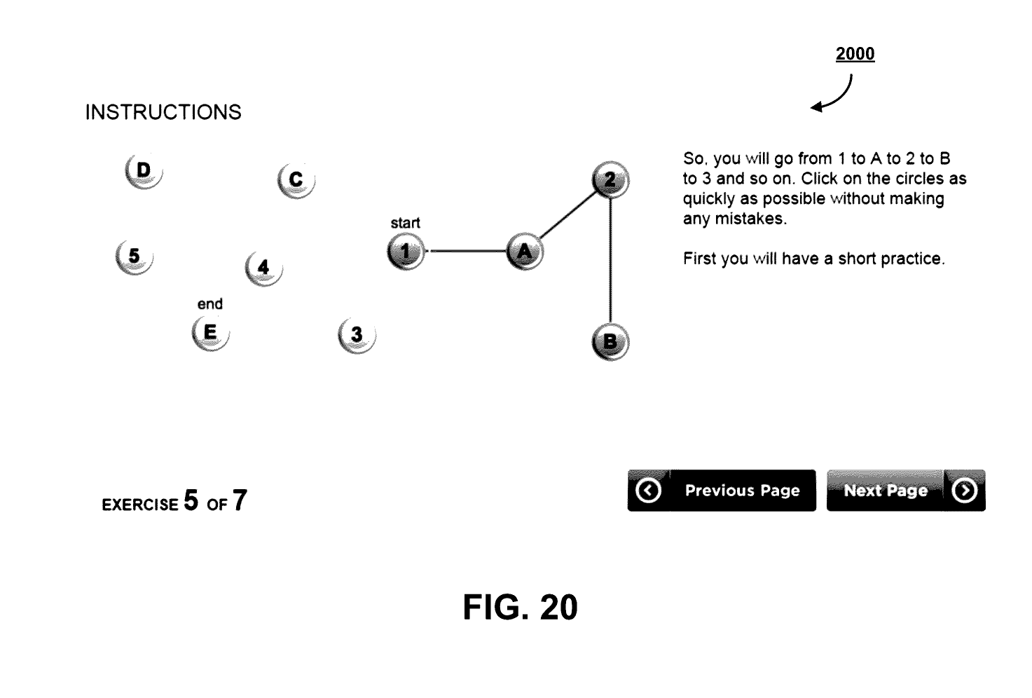

Screen shots from the tool are shown in FIGS. 3, 5-22B. The full test battery is available from www.cogniciti.com.

FIG. 3 is a screenshot illustrating the four tasks together, according to some embodiments.

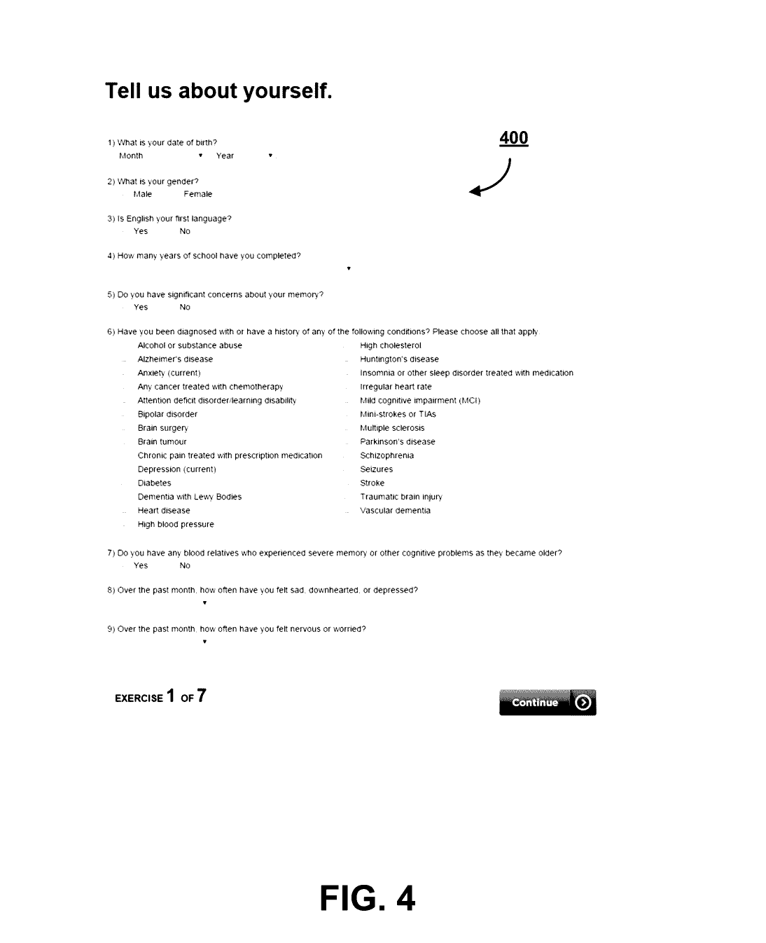

FIG. 4 is a screenshot illustrating a screen where various information is requested in the form of a questionnaire, according to some embodiments.

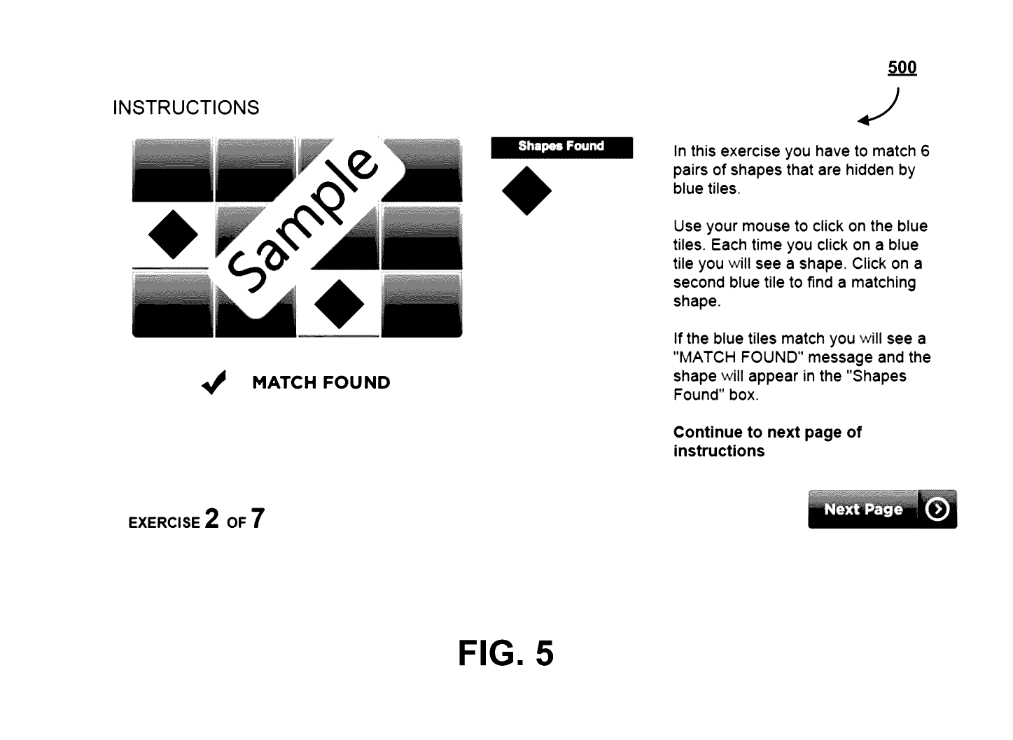

FIGS. 5-7 are screenshots of instructions provided in relation to the spatial working memory task, according to some embodiments.

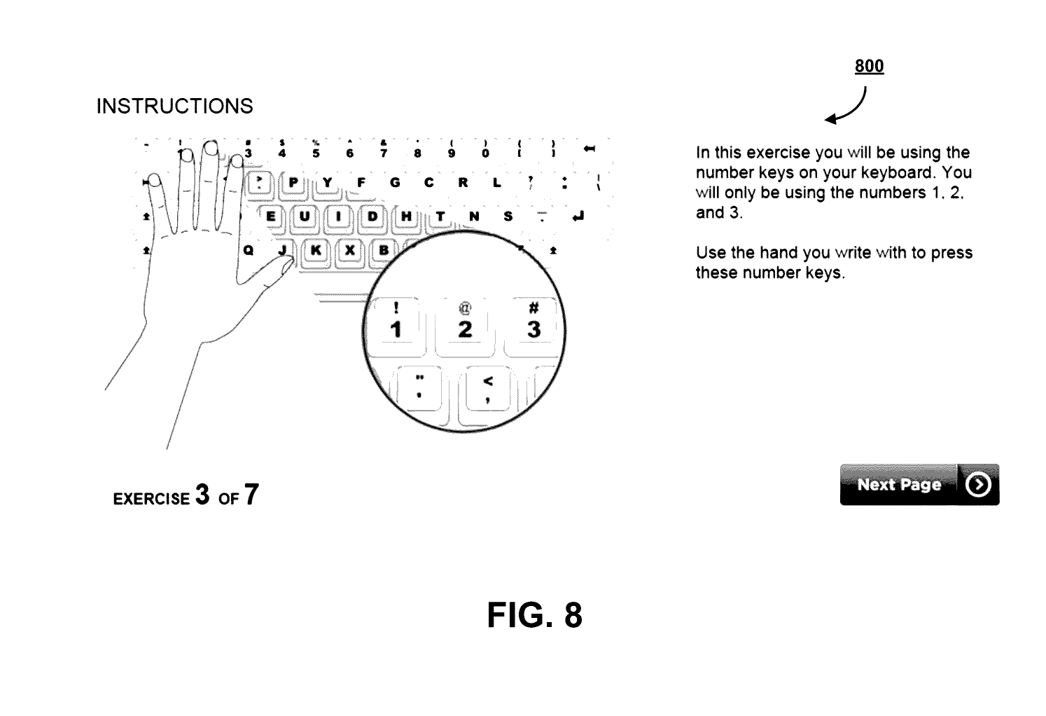

FIGS. 8-11 are screenshots of instructions provided in relation to the Stroop task, according to some embodiments.

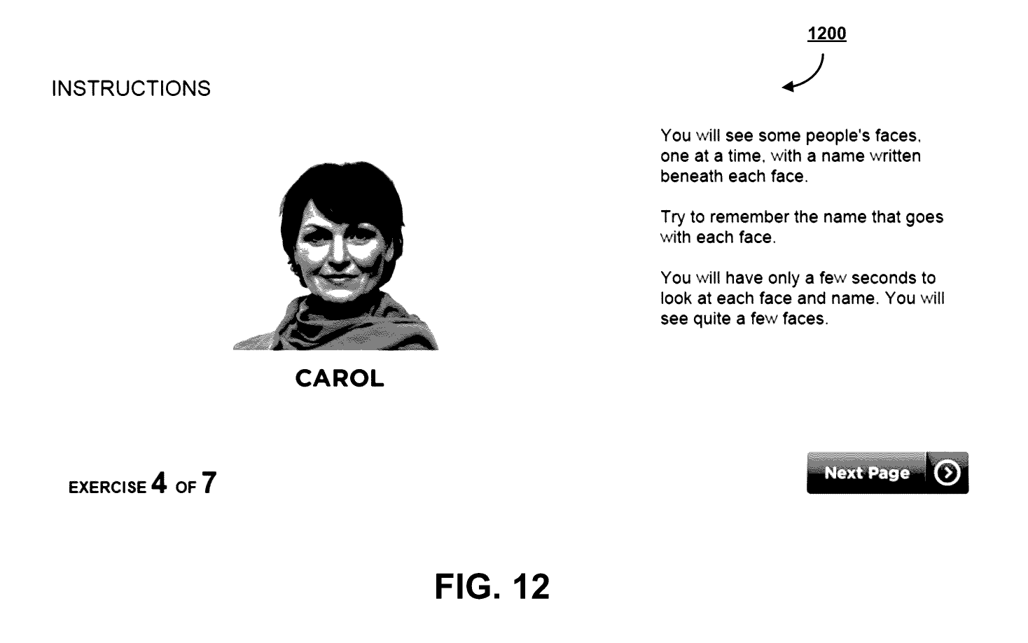

FIGS. 12-17 are screenshots of instructions provided in relation to the Face-Name association task, according to some embodiments.

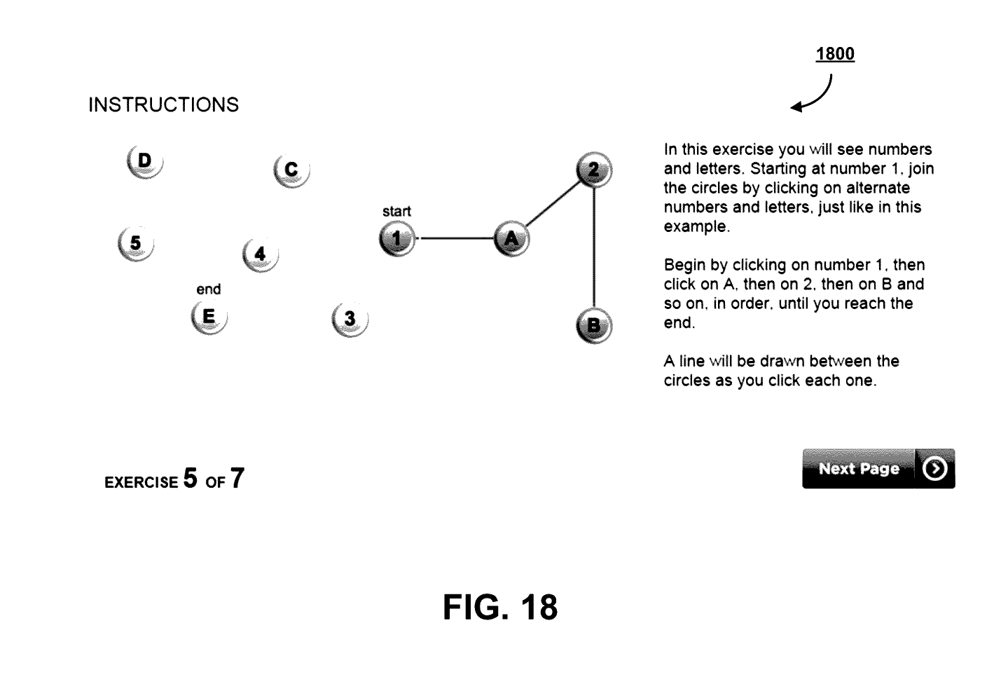

FIGS. 18-20 are screenshots of instructions provided in relation to the trail marking task, according to some embodiments.

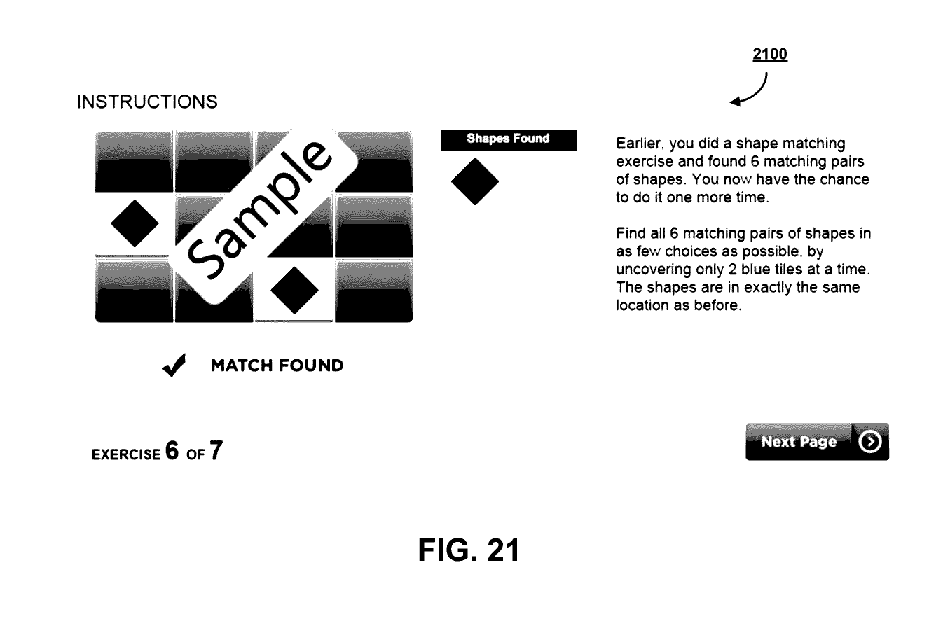

FIG. 21 is a screenshot of instructions provided in relation to a second spatial working memory task, according to some embodiments.

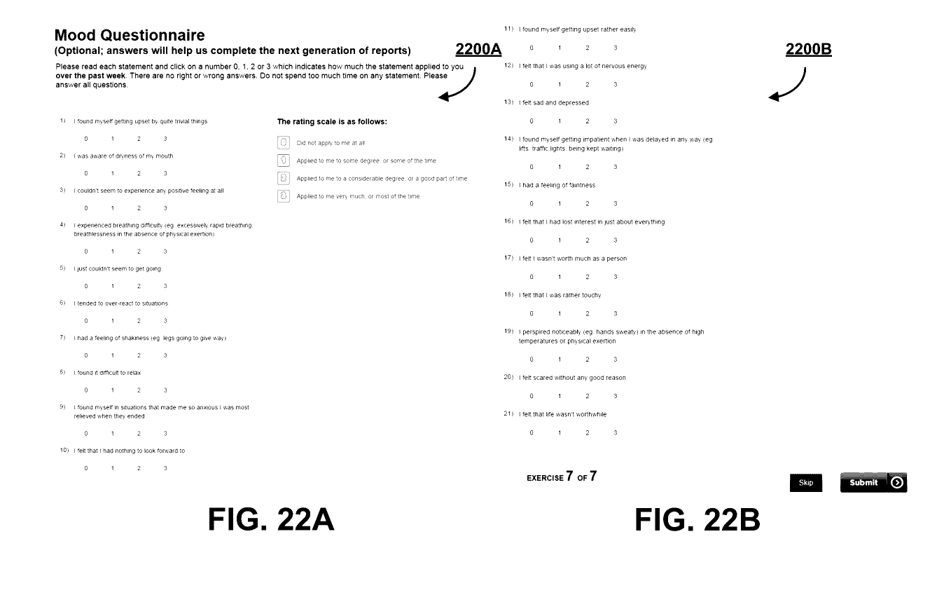

FIGS. 22A and 22B are screenshots of test results provided to a test taker, according to some embodiments.

The task included the display of a 4 by 3 array of rectangular tiles on the computer screen. The array contained 6 pairs of shapes (e.g., triangles, pentagons, circles, or sunbursts), with each tile hiding one shape. Participants clicked with the mouse on tiles to reveal the shape beneath.

Only two shapes could be seen at any time, and after each pair of clicks, both shapes were shown for 1 second. Each time two matching shapes were uncovered, that shape appeared in a “shapes found” box located to the right of the target array.

Thus, participants did not have to remember which shape pairs they had already located, rather they had to keep track of previously searched locations within working memory to reduce errors (e.g., uncovering two unmatched locations or two previously matched locations). The participant's task was to find all 6 pairs of shapes in as few clicks as possible. Once all pairs had been discovered, additional trials, using the identical array, were administered immediately and again at the end of the end of the entire test session. The number of responses and the time in seconds required to find all 6 pairs of shapes were recorded for each of the three trials.

Based on the original task developed by Stroop, the investigators created a number-word interference task using simple words (e.g., “call” and “then”) and written number words (i.e., “one,” “two,” and “three”). On each trial, participants were required to indicate the number of words shown on the screen by pressing the number keys 1, 2, or 3 as quickly as possible without making any mistakes.

Three types of trials were presented in an inter-mixed, pseudo-random order: neutral trials, consisting of non-number words (e.g., “and and and”); congruent trials, in which the number words corresponded to the number of works presented (e.g., “two two”); and incongruent trials, in which the number words did not correspond to the number of words presented (e.g., “three”).

There were 30 trials of each condition, for a total of 90 trials. Participants were not given feedback on their responses and were not allowed to correct any incorrect responses. This task was self-paced, with each stimulus remaining on the screen until the participant responded (for a maximum of 4 s), and a 500 millisecond inter-stimulus interval between trials.

Any failures to respond within 4 s were scored as incorrect responses, and these occurred very rarely (i.e., 0.1% of all responses). Accuracy for each response and reaction times (RTs) for correct responses were recorded and were averaged for each of the three trial types.

The Face-name task was configured to provide a series of male and female faces, the faces reflecting a wide range of ages and ethnic groups, and the faces were obtained from on-line databases (e.g., Shutterstock™, iStock™, Veer™).

First names were taken from a listing of the most common baby names from the past 100 years and were paired with age- and gender-appropriate faces. A total of 24 face-name pairs were presented individually for 3 s each (with a 500 millisecond inter-stimulus interval) across two presentation trials.

Immediately following (e.g., shortly after) the second list presentation, a yes/no recognition test consisting of 12 intact and 12 recombined face-name pairs was administered. Participants were instructed to click on a “yes” button for face-name combinations included in the encoding list and a “no” button for recombined items. This recognition task was self-paced, with each face-name pair remaining on the screen until the participant responded (for a maximum of 10 seconds), and a 500 millisecond inter-stimulus interval between trials. Any failures to respond within 10 second were scored as incorrect responses, and these occurred rarely (i.e., 0.5% of all responses). Accuracy for each response and RTs for correct responses were recorded.

The fourth task was based on the trail-making test used in neuropsychological assessment. A display of 16 buttons, each containing a number from 1 to 8 or a letter from A to H, was shown on the screen. Participants were instructed to click on the numbers and letters in alternating order (e.g., 1, A, 2, B, 3, and so on), starting with the number 1 and ending with the letter H, as quickly and as accurately as possible.

With each click, a line appeared connecting the consecutive items. Incorrect responses were immediately identified, and participants were required to determine and click on the correct number or letter before proceeding. Accuracy and total time required to complete the sequence were measured.

Participants provided consent and completed a medical history and cognitive screen by telephone. Subsequently, they received two e-mail messages 1 week apart containing instructions and links for completing the on-line test in their own homes.

The on-line component consisted of reading general instructions for the test, completing a demographic and health questionnaire, completing the four tasks, and providing (optional) feedback about the research. A total of 396 participants completed the test at least once, 288 of whom completed it on both occasions.

Subsequent analyses indicated that participants taking the test only once (n=108) and those taking it twice (n=288) did not differ on the four targeted test scores, F_{(4,391)}<1, p=0.43, η²ₚ=0.01. Of those completing the test twice, participants received either the same (n=76) or an alternate (n=212) version on the second occasion. The four test versions were counterbalanced across test occasions and were used approximately equally often.

Of the 797 occasions on which the test was started during our recruitment period, there were 696 (87%) completions. Of these, 656 (94%) test completions produced data within 3 standard deviations of the group mean on each of the four tasks and were not considered to be outliers.

Descriptive data obtained from participants' first test occasion, collapsed across the four test versions, are presented in Table 2. All analyses described subsequently were conducted on raw test scores, with the exception of those involving the overall score, which is derived from demographically corrected normative scores.

TABLE 2
Descriptive test data for scores obtained on the first test occasion.

| | 5-year age groups | | | | | | | | | | | |
|---|---|---|---|---|---|---|---|---|---|---|---|---|
| | 50-54 | | 55-59 | | 60-64 | | 65-69 | | 70-74 | | 75-79 | |
| | (n = 39) | | (n = 72) | | (n = 82) | | (n = 57) | | (n = 54) | | (n = 57) | |
| Spatial Working Memory: | | | | | | | | | | | | |
| Trial 1 responses | 36.4 | (12.6) | 41.0 | (19.1) | 42.6 | (18.9) | 43.4 | (23.9) | 42.1 | (16.2) | 45.3 | (17.1) |
| Trial 2 responses | 29.6 | (13.7) | 31.2 | (17.3) | 31.7 | (14.3) | 32.0 | (12.6) | 34.2 | (12.7) | 38.7 | (15.2) |
| Trial 3 responses | 26.7 | (10.8) | 30.6 | (15.6) | 30.0 | (13.7) | 29.2 | (12.7) | 31.6 | (19.6) | 33.9 | (12.3) |
| *Trial 1-3 responses | 92.8 | (25.0) | 102.8 | (37.3) | 104.3 | (39.1) | 104.5 | (36.7) | 107.9 | (34.2) | 117.9 | (30.2) |
| Trial 1 time to completion (s) | 82 | (35) | 98 | (45) | 108 | (65) | 114 | (61) | 116 | (56) | 126 | (63) |
| Trial 2 time to completion (s) | 69 | (37) | 76 | (40) | 76 | (40) | 83 | (40) | 90 | (37) | 101 | (56) |
| Trial 3 time to completion (s) | 56 | (26) | 66 | (32) | 68 | (34) | 68 | (32) | 78 | (43) | 82 | (37) |
| Stroop Interference: | | | | | | | | | | | | |
| Congruent: % accuracy | 98 | (6) | 99 | (3) | 100 | (2) | 96 | (14) | 99 | (16) | 100 | (1) |
| Neutral: % accuracy | 98 | (5) | 99 | (4) | 99 | (2) | 96 | (16) | 99 | (2) | 99 | (3) |
| Incongruent: % accuracy | 96 | (5) | 96 | (5) | 97 | (4) | 95 | (14) | 98 | (4) | 96 | (5) |
| Congruent: median RT (ms) | 931 | (154) | 969 | (180) | 1038 | (169) | 1086 | (167) | 1075 | (172) | 1107 | (162) |
| Neutral: median RT (ms) | 957 | (158) | 993 | (179) | 1052 | (152) | 1092 | (159) | 1100 | (155) | 1132 | (160) |
| *Incongruent: median RT (ms) | 1027 | (174) | 1058 | (204) | 1129 | (173) | 1159 | (171) | 1163 | (176) | 1210 | (178) |
| Face-Name Association: | | | | | | | | | | | | |
| Hits (out of 12) | 10.6 | (1.3) | 10.2 | (1.9) | 9.7 | (1.7) | 10.2 | (1.7) | 9.8 | (1.8) | 9.4 | (1.7) |
| False alarms (out of 12) | 2.1 | (2.5) | 2.1 | (1.7) | 2.8 | (1.9) | 2.5 | (1.9) | 2.4 | (1.5) | 3.2 | (2.3) |
| *% accuracy | 85 | (12) | 84 | (11) | 79 | (13) | 82 | (10) | 80 | (11) | 75 | (13) |
| Median RT (ms) | 2023 | (494) | 2385 | (847) | 2427 | (802) | 2524 | (610) | 2766 | (942) | 2938 | (1081) |
| Letter-Number Alternation: | | | | | | | | | | | | |
| % accuracy | 95 | (10) | 95 | (11) | 96 | (8) | 94 | (11) | 96 | (9) | 94 | (13) |
| *Time to completion (s) | 31 | (13) | 35 | (18) | 32 | (13) | 35 | (13) | 34 | (15) | 38 | (17) |

Note:
RT = reaction time for correct responses.
Data are presented as means (or medians) and standard deviations.
*Target variable for each respective task.

One target measure for each task was selected based on an examination of the distribution of scores as well as analyses of internal consistency and reliability. These target measures are indicated with asterisks in Table 2, and include the number of responses required to complete each trial summed across the three trials of the Spatial Working Memory task, median RT on correct responses to incongruent trials on the Stroop Interference task, overall percent accuracy on the 24 test trials of the Face-Name Association task, and time required to complete the sequence on the Letter-Number Alternation task.

For each task, z-scores were calculated from the normative sample. To determine which characteristics to take in to account in calculating the normative z-scores, the investigators used MANOVAs and repeated-measures ANOVA to examine the effects of demographic and test variables on the four test scores. There were significant overall effects of age group, F_{(20,1420)}=3.59, p<0.001, η²ₚ=0.05, education group, F_{(12,1068)}=1.79, p=0.045, η²ₚ=0.02, test version, F_{(12,1068)}=2.46, p<0.004, η²ₚ=0.03, and test occasion, F_{(4,261)}=16.27, p<0.001, η²ₚ=0.20.

There was no significant effect of sex on overall performance, F_{(4,365)}=1.07, p=0.37, η²ₚ=0.01. For those characteristics with significant overall effects, the investigators examined the effect sizes for each individual task. Based on these analyses, normative data were broken down by age group for the Spatial Working Memory and Letter-Number Alternation tasks, by age group and test version for the Face-Name Association task, and by age group and test occasion for the Stroop Interference task A.

An overall score was calculated as the mean of the four z scores, and a cut-off score of −1.50 was determined based on observed clusters of scores at the low end of the distribution curve. Eight of the 361 participants in the normative sample obtained a score below this cut-off, yielding a failure rate of 2%.

As a measure of internal consistency, the split-half correlation of the 24 responses on the Face-Name Association test was calculated as 0.62. Cronbach's alpha for the 30 incongruent items of the Stroop Interference task was 0.96. The other two tasks did not have a sufficient number of trials to calculate internal consistency.

Test-retest reliability was calculated from the 76 participants who completed the same test version on two occasions. As seen in Table 3, test-retest reliability ranged from r(74)=0.49 to 0.82 for the individual tasks, and was 0.72 for the overall score. All correlations were significant, p's<0.01.

TABLE 3
Test-retest and alternate-version reliability.

| | Test-retest | Alternate-version |
|---|---|---|
| | (n = 76) | (n = 212) |
| Spatial Working Memory | 0.49 | 0.52 |
| Stroop Interference | 0.83 | 0.82 |
| Face-Name Association | 0.66 | 0.48 |
| Letter-Number Alternation | 0.49 | 0.52 |
| Overall score | 0.72 | 0.69 |

Note:
Target values are the number of responses to completion summed across the three trials of the Spatial Working Memory task, median RT on correct responses to incongruent trials on the Stroop Interference task, overall percent accuracy on the Face-Name Association task, and time to completion on the Letter-Number Alternation task; overall score is the mean of the four demographically corrected z scores. Values presented are Pearson's r. All correlations are significant at p < 0.01.

Alternate-version reliability was calculated from the 212 participants who completed different versions of the test on two occasions. As seen in Table 3, alternate-version reliabilities ranged from r(210)=0.48 to 0.82 for the individual tasks, and was 0.69 for the overall score. All correlations were significant, p's<0.01.

As a measure of construct validity, correlations between age and the target measures for each task were calculated. As seen in Table 4, these correlations were small to medium in size, r(394)=−0.20 to 0.31, and were all statistically significant, p's<0.01.

TABLE 4
Correlations with age and between tasks.

| | Spatial | | Face- | Letter- |
|---|---|---|---|---|
| | working | Stroop | name | number |
| | memory | interference | association | alternation |
| Age | 0.17 | 0.31 | −0.20 | 0.14 |
| Spatial Working | 1 | | | |
| Memory | | | | |
| Stroop Interference | 0.18 | 1 | | |
| Face-Name | −0.27 | −0.18 | 1 | |
| Association | | | | |
| Letter-Number | 0.21 | 0.30 | −0.22 | 1 |
| Alternation | | | | |

Note:
Target values are the number of responses to completion summed across the three trials of the Spatial Working Memory task, median RT on correct responses to incongruent trials on the Stroop Interference task, overall percent accuracy on the Face-Name Association task, and time to completion on the Letter-Number Alternation task. Values presented are Pearson's r. N = 396. All correlations are significant at p < 0.01.

The investigators further assessed construct validity of the Spatial Working Memory task by examining learning over repeated trials. Consistent with expectations, performance on the three trials differed significantly in the number of responses required for completion, F_{(2,734)}=76.7, p<0.001, η²ₚ=0.17, and the amount of time taken, F_{(2,732)}=118.2, p<0.001, η²ₚ=0.24. Examination of the data in Table 2 showed the expected performance improvements across the three learning trials.

The investigators assessed the construct validity of the Stroop Interference task by examining the effects of congruency. Consistent with the Stroop effect, performance on the three types of Stroop trials differed significantly in both accuracy, F_{(2,734)}=72.8, p<0.001, η²ₚ=0.17, and median RT for correct responses, F_{(2,734)}=391.5, p<0.0001, η²ₚ=0.52. Examination of the data in Table 2 shows that, numerically, accuracy scores decreased and speed scores increased from congruent to neutral to incongruent trials.

As a measure of convergent validity, the investigators examined inter-task correlations of the target measures, which are shown in Table 3. These correlations were small to medium in size, r₍₃₉₄₎=−0.27 to 0.30, and were statistically significant, p's<0.01.

To determine the component structure, the investigators conducted an initial principal component analysis (PCA) from the first test occasion (n=396). This showed that all 4 tasks loaded on a single component (Eigenvalue=1.61), with individual component loadings ranging from 0.58 to 0.75.

Given the investigators' inclusion of two types of cognitive tasks—namely, memory and speeded executive attention tasks—the investigators conducted another PCA with the same data, forcing two components and using a varimax rotation.

The Spatial Working Memory task and Face-Name Association task loaded highly on the first component (Eigenvalue=1.61), with rotated component loadings of 0.75 and 0.80, respectively. This was interpreted as a memory component. The Stroop Interference and Letter-Number Alternation tasks loaded highly on the second component (Eigenvalue=0.95), with rotated component loadings of 0.86 and 0.71, respectively. This was interpreted as a speeded executive attention component.

To replicate the component structure, the investigators repeated these PCAs on the subsample (n=288) that took the test on a second occasion. The results were similar to the first analyses, with all 4 tasks loading on a single component (Eigenvalue=1.61) and individual component loadings ranging from 0.57 to 0.79. When forcing two components and using a varimax rotation, the Spatial Working Memory task and Face-Name Association task loaded highly (0.73 and 0.80, respectively) on the first component (Eigenvalue=1.61), and the Stroop Interference and Letter-Number Alternation tasks loaded highly (0.89 and 0.65, respectively) on the second component (Eigenvalue=0.98).

The standard error of measurement at the cut-off score of −1.50 was 0.35 (95% confidence interval=−1.51 to −0.56). Classification consistency, measured as percent of participants who scored above or below the cut-off on both test occasions, was excellent, 98%, Fisher's exact p<0.001. Most participants (273 out of 282) obtained scores above the cut-off at both occasions, and 3 participants obtained scores below the cut-off at both occasions. The 6 participants who obtained a score below the cut-off on only one occasion also obtained low scores on the remaining occasion, ranging from −1.14 to −0.64.

The investigators validated an on-line cognitive screening instrument to provide rapid, reliable information regarding relative preservation or impairment in cognition relative to one's age peers.

Rather than assessing gross mental status, as is the case in standard dementia screening tools, the investigators focused on specific cognitive abilities that may precede the onset of a full-blown dementia syndrome. Thus a goal of this investigation was to define the normal range of responses in a healthy sample to determine appropriate cut-off scores that may signal the need for more in-depth assessment. The investigators drew from clinical neuropsychological assessment and cognitive neuroscience research on healthy aging and dementia to provide measures with the greatest potential for identifying the changes in memory and executive functioning that herald atypical brain aging.

The investigation results suggest that a web-based cognitive assessment can feasibly provide meaningful results for individual test takers. Technical and human errors were minimized, such that 87% of tests started were fully completed. Of the tests that were completed, 94% produced results within the expected range on all 4 tasks, suggesting that there were no undue errors that introduced bias into the results.

These feasibility findings are notable, given the challenges of automated, remote testing. Whereas such instruments can never be as flexible as in-person evaluation, extensive piloting insured that respondents could follow the instructions and produce data of sufficient quality. The investigators also utilized a web-based platform that could collect data in a consistent manner across a variety of browser and hardware configurations, and the investigators created extensive instructions, practice trials, and feed-back to anticipate any potential problem in comprehension of instructions or task execution. In this respect, our web-based administration implemented the guidance provided by one-on-one testing.

Detailed psychometric testing showed acceptable reliability of the test. The test-retest reliability of 0.72 for the overall test score provides evidence for stability over time. Although test-retest reliabilities for some of the individual tasks were relatively lower, this is not an unusual finding. The tasks compare favorably with those of standard neuropsychological tests measuring similar constructs administered to middle- and older-adult age groups. That is, reliability coefficients for a Letter-Number Alternation (r=0.49) and Stroop Interference task (r=0.83) are the same as or higher than those from the Trail-Making Test switching condition (r=0.55) and the Color-Word Interference Test inhibition condition (r=0.50) from the Delis-Kaplan Executive Function System. The reliabilities of a Spatial Working Memory (r=0.49) and Face-Name Association (r=0.66) tasks are similar to those of the immediate and delayed Designs Spatial task (r's=0.56 and 0.50) and immediate Face Recognition (r=0.64) from the Wechsler Memory Scale. Alternate form reliability for the overall test score (r=0.69) supported the use of this tool for serial testing, where practice effects could artificially elevate scores if the same form were used. Notably, given the difference in reliabilities for the overall score vs. the individual tasks, the main score for interpretation is the overall score.

Construct validity was supported by correlations between test performance and age, as expected given age-related changes in speed, attention, memory, and executive functioning. Moreover, within-test comparisons across conditions were consistent with established psychological principles. The expected learning curve was demonstrated across trials of the Spatial Working Memory task and the expected interference effect was demonstrated on the Stroop Interference task.

The principal components analysis conservatively identified a single factor solution that was used to derive cut-off scores for this measure. This cut-off identified eight out of 361 (2%) participants as candidates for further assessment. There was also evidence in support of a two-factor solution that reflected constructs of memory and executive attention in the context of speeded responding. The possibility of a one- or two-factor solution was not surprising given recent theoretical work suggesting that attention regulation underlies memory.

The validity of the factor structure with respect to gold-standard measure may be used. If supported, a two-factor solution could provide more nuanced feedback relating to selective preservation or impairment in mnemonic or executive processes.

In spite of the limitations in web-based cognitive assessment, the investigators attained a high degree of control over the delivery of instructions and automated management of responses, as demonstrated by our feasibility, reliability, and validity data.

It is nonetheless acknowledged that individuals who complete on-line testing do so in an uncontrolled environment where fatigue, medications, mood, time of day, effort and numerous other factors might affect test performance. Whereas these same factors also affect performance in a standard testing situation, the examiner processor can take these into account when interpreting the data through heuristic data analysis and historical benchmarking.

For these reasons, in general, embodiments may process a detailed history of data to be included with web-based assessments so that endorsement of potentially confounding factors can be reported and subsequently taken into consideration. Similarly, feedback delivered to the participant device may be processed according to device capabilities and detected real-time feedback monitoring.

The inclusion of validated alternate forms enables the option of repeat testing in the case of ambiguous results or transient factors affecting test performance. Although web-based testing will always be less controlled than in-person testing, the investigators note that many individuals may not seek in-person assessment due to anxiety, lack of access, or other factors. In this respect, web-based testing provides useful feedback to guide individuals in making a decision whether to pursue further assessment.

As the sample was limited to adults aged 50-79, the test was not recommended for individuals falling outside of this age range. The investigators had difficulty recruiting unpaid volunteers with lower education, so the investigators paid a small number of volunteers to fill these cells. Although the investigators could detect no statistically significant effect of payment on test results, the investigators nonetheless recommend caution in interpreting scores from those with lower education, which can affect performance for reasons other than cognitive decline. The availability of the test to the public will result in larger sample sizes that will allow the investigators to examine more closely the impact of specific demographic variables on the task.

It was expected that those with advanced cognitive decline would fall below the observed cut-off scores. An approach was to specify a cut-off score as an empirical criterion to identify those falling outside the normal range of cognitive functioning for follow-up assessment, not to diagnose brain disease. The processor may be tuned for assessing the sensitivity and specificity of this instrument in relation to brain disease.

Specifically, tuning data may involve assessment of on-line tasks as compared to tasks accepted to measure similar cognitive constructs. This would provide evidence of the ability of the test to measure working memory, associative memory, and executive attention.

Overall, the experimental findings support the feasibility, reliability, and validity of this online assessment tool and its use as a screening measure to detect greater than expected changes in cognitive functioning in middle-aged and older adults. The need for such a test is likely to grow, as the projected number of adults in this age group increases, along with the incidence of age-related cognitive disorders such as dementia.

The standard paradigm of one-on-one assessment in a doctor's office cannot support this increasing need, which will be composed of both those with genuine cognitive decline due to incipient dementia and the “worried well” seeking reassurance. On-line assessment that does not require individualized attention from a healthcare professional has the potential to significantly reduce demand on the healthcare system, allowing resources to be more efficiently targeted to those truly in need.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references are made regarding servers, services, interfaces, portals, platforms, or other systems formed from computing devices.

It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may tune and dynamically adjust the brain testing computations based on the client devices used by test taker. Further, different selections of assessments may be tailored to different client devices depending on capabilities and specifications of output components and input components of the client device. The modular nature of the system enables separate testing data storage devices to connect to interface server to receive testing data streams to provide physical barriers between testing data, for memory capacity issues, privacy and security issues, and so on. The cloud support platform may enable connectivity to various physical devices.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information.

The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

For simplicity only one computing device 2400 is shown but system may include more computing devices 2400 operable by users to access remote network resources and exchange data. The computing devices 2400 may be the same or different types of devices particularly configured as described herein. The computing device 2400 at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”). For example, and without limitation, the computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or computing devices capable of being configured to carry out the methods described herein.

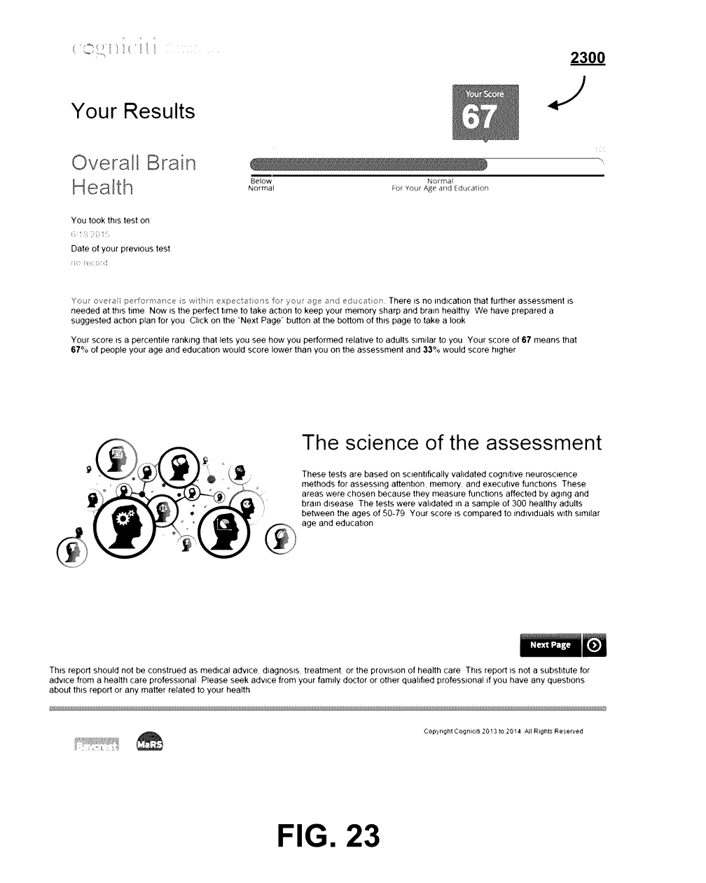

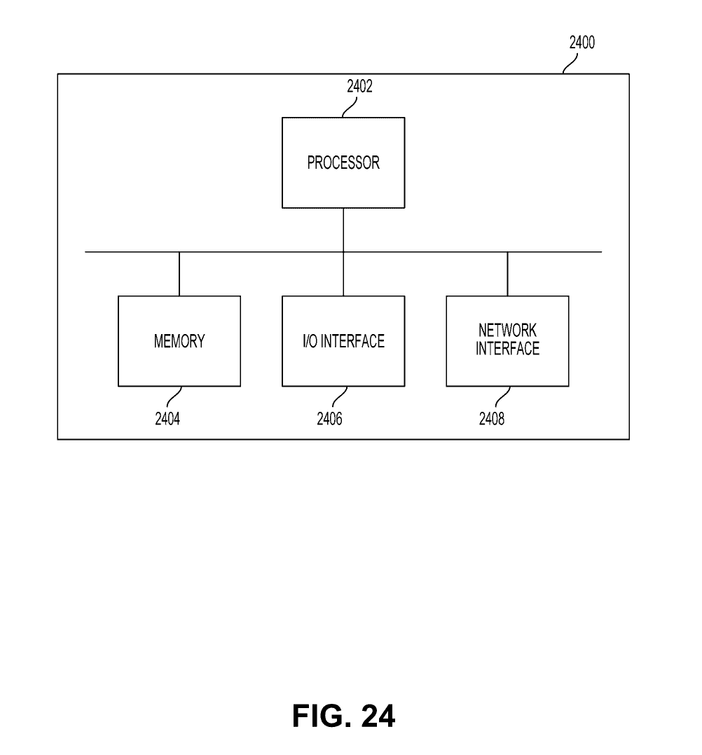

FIG. 23 is a schematic diagram of computing device 2400, according to some embodiments. As depicted, computing device 2400 includes at least one processor 2402, memory 2404, at least one I/O interface 2406, and at least one network interface 2408.

Each processor 2402 may be, for example, a microprocessor or microcontroller, a digital signal processing (DSP) processor, an integrated circuit, a field programmable gate array (FPGA), a reconfigurable processor, a programmable read-only memory (PROM), or combinations thereof.

Memory 2404 may include a suitable combination of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 2406 enables computing device 2400 to interconnect with one or more input devices, such as a keyboard, mouse, camera, touch screen and a microphone, or with one or more output devices such as a display screen and a speaker.

Each network interface 2408 enables computing device 2400 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including combinations of these.

Each computing device 2400 is operable to register and authenticate users (using a login, unique identifier, and password for example) prior to providing access to applications, a local network, network resources, other networks and network security devices. Computing devices 2400 may serve one user or multiple users.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A brain assessment system comprising:
(a) an interface server that hosts a client site or application for establishing a communication interface connection to one or more client devices to receive test-taker identification information and an electronic indication of consent to collection of test data, and send a software and device request signal to check for software and device compatibility, functionality and attributes where the interface server generates and transmits a test-taker token and a session ID token after validation of the test-taker identification information and processing of the software and device compatibility, functionality and/or attributes;
(b) a test server for a brain assessment tool that receives the test-taker token and a session ID token and after validation generates an electronic brain testing instance for a client device to compute brain testing results, the electronic brain testing instance having a test ticket identifier token for the session ID and customized according to the software and device compatibility, functionality and/or attributes;
(c) the interface server monitoring input components of the client device to detect test response times for the electronic brain testing instance;
(d) the interface server tuning the test response times and the brain testing results based on the software and device compatibility and processing times;
(e) the test server computing a test report based on normalization of the brain testing results to provide a score relative to adults of similar gender, education, and age; and
(f) one or more data storage devices to store the brain testing results, the test ticket identifier token, the session ID, and the test-taker identification information.

2. The brain assessment system of claim 1 further comprising a storage manager for a plurality of customer data storage devices linked to a corresponding plurality of customer identifiers, wherein the interface server receives a customer identifier from a client device and the storage manager triggers storing based on the customer identifier in a corresponding customer data storage device of the brain testing results, the test ticket identifier token, the session ID, and the test-taker identification information for the customer.

3. The brain assessment system of claim 1 wherein the brain assessment tool is based on the examination of memory, attention, and executive function and the score is generated as a combination of different test results and data transformations provided by different tests of the electronic brain testing instance.

4. The brain assessment system of claim 1 wherein the score may be filtered to include sub-scores that may link to different cognitive functions or ailments.

5. The brain assessment system of claim 1 wherein the score is updated and tracked over time using the test-taker identification information and learning results tuning processes to provide benchmarking.

6. The brain assessment system of claim 1 wherein the normalization of the brain testing results is based on a comparison to a database of test results.

7. The brain assessment system of claim 1 wherein the test server normalizes brain testing results based on previous brain testing results.

8. The brain assessment system of claim 7 wherein the test server receives information from previous brain testing results from one or more remote computing devices.

9. The brain assessment system of claim 1 wherein normalization of the brain testing results includes normalization based on at least one of device characteristics and network characteristics.

10. The brain assessment system of claim 1 wherein the test server is configured to automatically generate suggestions for improvement of areas tested in where test results scored below a predefined threshold.

11. The brain assessment system of claim 1 wherein an interface server sends and/or receives information to an interface on one or more computing systems associated with one or more healthcare providers to activate the display of the electronic brain testing instances on the computing system.

12. The brain assessment system of claim 1 further comprising a test modification module that modifies the electronic testing instances when a determination is made identifying repeated test taking by the test-taker.

13. The brain assessment system of claim 5 wherein the score is sent to a healthcare provider and/or user device.

14. The brain assessment system of claim 1 wherein the software and device attributes relate to test data exchange and may include network protocol, communication protocol, communication type.

15. A brain assessment process comprising:
(a) providing an interface server that hosts a client site or application for establishing a communication interface connection to one or more client devices to receives test-taker identification information and an electronic indication of consent to collection of test data, and send a software and device request signal to check for software and device compatibility, functionality and attributes where the interface server generates and transmits a test-taker token and a session ID token after validation of the test-taker identification information and processing of the software and device compatibility, functionality and/or attributes;
(b) receiving the test-taker token and a session ID token and after validation generates an electronic brain testing instance for controlling the client device to compute brain testing results, the electronic testing instance having a test ticket identifier token for the session ID and customized according to the software and device compatibility, functionality and/or attributes;
(c) monitoring input components of the client device using the interface server to detect test response times for the electronic testing instance;
(d) tuning the test response times and the brain testing results using the interface server based on the software and device compatibility and processing times;
(e) computing a test report based on normalization of the brain testing results to provide a score relative to adults of similar gender, education, and age; and
(f) storing or transmitting the brain testing results, the test ticket identifier token, the session ID, and the test-taker identification information.

16. The brain assessment process of claim 15 further comprising managing a plurality of customer data storage devices linked to a corresponding plurality of customer identifiers, receiving a customer identifier from a client device, and securely storing in a corresponding customer data storage segment linked to the customer identifier of the brain testing results, the test ticket identifier token, the session ID, and the test-taker identification information for the customer.

17. The brain assessment process of claim 15 wherein the brain assessment tool is based on the examination of memory, attention, and executive function and the score is generated as a combination of different test results and data transformations providing by different tests of the electronic testing instance.

18. The brain assessment process of claim 15 wherein the score may be filtered to include sub-scores that may link to different cognitive functions or ailments.

19. The brain assessment process of claim 15 wherein the score is updated and tracked over time using the test-taker identification information and learning results tuning processes to provide benchmarking.

20. The brain assessment process of claim 15 further comprising modifying the electronic testing instances when a determination is made identifying repeated test taking by the test-taker.

21. The brain assessment process of claim 15 wherein the software and device attributes relate to test data exchange and may include network protocol, communication protocol, communication type.
